(19) United States
(12) Patent Application Publication
(10) Pub. No.: US 2024/0407291 A1
(43) Pub. Date: Dec. 12, 2024

(54) SYSTEMS AND METHODS FOR DRIVE-BY-WIRE IN OUTDOOR POWER EQUIPMENT

(71) Applicant: MTD PRODUCTS INC, Valley City, OH (US)

(72) Inventors: Zachary A. Lyzen, Seattle, WA (US); Adam Woodrum, Wakeman, OH (US); Katharin Jensen-Nau, Crystal, MN (US)

(21) Appl. No.: 18/737,461

(22) Filed: Jun. 7, 2024

Related U.S. Application Data
(60) Provisional application No. 63/471,867, filed on Jun. 8, 2023.

(51) Int. Cl. A01D 34/64; B62D 5/04

(52) U.S. Cl. CPC A01D 34/64; B62D 5/0418

(57) ABSTRACT

Systems and methods for drive and steering control in a drive-by-wire system for outdoor power equipment are discussed. Various embodiments can employ techniques related to one or more of: steering based on actively steered wheels with zero caster trail, variable output damping of vehicle control outputs, steering that compensates for drive system loss, emulation of drivability of a hydrostatic drive system by a non-hydrostatic drive system, employing a floating neutral point to improve steering on slopes, open loop techniques for hill holding and speed compensation on hills, and/or adjustment of a speed range associated with control inputs.

### CROSS-REFERENCE TO RELATED APPLICATION

This application for patent claims the benefit of priority from U.S. Provisional Patent Application No. 63/471,867 filed Jun. 8, 2023, and titled SYSTEMS AND METHODS FOR DRIVE-BY-WIRE IN OUTDOOR POWER EQUIPMENT, which is hereby incorporated by reference herein in its entirety and for all purposes.

### INCORPORATION BY REFERENCE

The following are hereby incorporated by reference within the present disclosure in their respective entireties and for all purposes: U.S. patent application Ser. No. 16/782,409 filed Feb. 5, 2020, U.S. Provisional Application No. 62/907,992 filed Sep. 30, 2019, U.S. Provisional Application No. 62/801,202 filed Feb. 5, 2019, U.S. Provisional Application No. 63/160,524 filed Mar. 12, 2021, U.S. Provisional Application No. 63/213,646 filed Jun. 22, 2021.

### FIELD OF DISCLOSURE

This application relates generally to outdoor power equipment, and more specifically to active steering for a drive-by-wire system employable in connection with outdoor power equipment.

### BACKGROUND

Manufacturers of power equipment for outdoor maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Many outdoor power equipment employ dummy caster wheels, which can support a non-driven end of the outdoor power equipment (e.g., front, rear, etc.) while allowing for steering via drive elements (e.g., drive wheels rotated at different speeds to turn the outdoor power equipment, etc.). Unlike fixed wheels, casters can rotate their orientation to appropriate angles whether the power equipment is turning or driving straight. However, in some situations, dummy caster wheels can lead to undesirable behavior. For example, when attempting to drive straight along the side of a hill, gravity will cause the caster wheels to rotate away from the proper alignment for driving straight, making steering extremely difficult.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

In various embodiments, the subject disclosure provides systems and methods for drive and steering control in a drive-by-wire system for outdoor power equipment. Various embodiments can employ techniques related to one or more of: steering based on actively steered wheels with zero or substantially zero caster trail, variable output damping of vehicle control outputs, steering that compensates for drive system loss, emulation of drivability of a hydrostatic drive system by a non-hydrostatic drive system, employing a floating neutral point to improve steering on slopes, open loop techniques for hill holding and speed compensation on hills, and/or adjustment of a speed range associated with control inputs. According to one aspect, an example outdoor power equipment is disclosed. The example outdoor power equipment comprises a frame; one or more drive elements coupled to the frame; a control unit configured to generate a first steering output based at least in part on one or more control inputs; and a steering system, comprising: a first steerable wheel coupled to the frame, wherein the first steerable wheel has zero caster trail; one or more steering motor controllers configured to receive the first steering output and to generate a first motor control signal based on the first steering output; and one or more steering motors configured to rotate the first steerable wheel to a first angle based on the first motor control signal.

Another aspect comprises an outdoor power equipment, comprising: a frame; and a control unit configured to: calculate at least one damping parameter based at least in part on one or more control inputs associated with at least one of driving the outdoor power equipment or steering the outdoor power equipment; calculate at least one control output value based at least in part on the operator input; generate a damped control output value by applying a damping function based on the at least one damping parameter to the at least one control output value; and output a vehicle control output to at least one motor controller based on the damped control output value.

A further aspect is an outdoor power equipment, comprising: a frame; a left drive element coupled to the frame and a right drive element coupled to the frame, wherein the left and right drive elements are configured to be driven independently of each other; a left steerable wheel coupled to the frame and a right steerable wheel coupled to the frame; and a control unit configured to: receive a left control input associated with the left drive element and a right control input associated with the right drive element; generate a left drive element command and a right drive element command based at least in part on the left control input and the right control input; determine an estimated left drive element response and an estimated right drive element response based at least in part on the left control input and the right control input; generate a left steering command based at least in part on the estimated left drive element response and the estimated right drive element response; and generate a right steering command based at least in part on the estimated left drive element response and the estimated right drive element response; and a steering control system configured to receive the left steering command and the right steering command, to rotate the left steerable wheel to a left steering angle associated with the left steering command, and to rotate the right steerable wheel to a right steering angle associated with the right steering command.

Still further aspects include an outdoor power equipment, comprising: a frame; a left drive element coupled to the frame and a right drive element coupled to the frame, wherein the left and right drive elements are configured to be driven independently of each other, wherein the left drive element is driven at least one of mechanically or electrically, and wherein the right drive element is driven at least one of mechanically or electrically; and a control unit configured to: receive a left control input associated with the left drive element and a right control input associated with the right drive element; generate a left drive element command based at least in part on the left control input and the right control input; and generate a right drive element command based at least in part on the left control input and the right control input; wherein the left drive element is configured to be driven based on the left drive element command, and wherein the right drive element is configured to be driven based on the right drive element command.

Another aspect comprises an outdoor power equipment, comprising: a frame; one or more drive elements coupled to the frame; one or more steerable elements coupled to the frame; operator controls configured to receive one or more operator inputs; and a control unit configured to receive at least one of vehicle pitch data or vehicle acceleration data; determine an effective tilt angle based on the at least one of the vehicle pitch data or the vehicle acceleration data; estimate a zero position for the operator controls that is associated with zero speed based on the effective tilt angle; assign the zero position as a neutral position of the operator controls; receive the one or more operator inputs via the operator controls; calculate an associated steering angle for each steerable element of the one or more steerable elements based on the one or more operator inputs relative to the neutral position; and output an associated steering angle command based on each of the associated steering angles; wherein each of the one or more steerable elements is configured to be steered based on the associated steering angle command based on the associated steering angle for that steerable element.

An additional aspect is an outdoor power equipment, comprising: a frame; one or more drive elements coupled to the frame; operator controls configured to receive one or more operator inputs; and a control unit configured to: receive at least one of vehicle pitch data or vehicle acceleration data; determine an effective tilt angle based on the at least one of the vehicle pitch data or the vehicle acceleration data; estimate a zero position for the operator controls that is associated with zero speed based on the effective tilt angle; compute a difference between the estimated zero position and a mechanical neutral position for the operator controls; determine one or more compensated operator inputs based on the one or more operator inputs and the difference between the estimated zero position and the mechanical neutral position; generate one or more drive element commands for the one or more drive elements based on the one or more compensated operator inputs; and output the one or more drive element commands; wherein the two drive elements are configured to be driven based on the one or more drive element commands.

A further aspect comprises an outdoor power equipment, comprising: a frame; one or more drive elements coupled to the frame; and a control unit configured to: receive a selected top speed input, wherein the selected top speed is associated with a maximum forward speed and a maximum rearward speed; receive one or more control inputs; generate one or more scaled control inputs based on the selected top speed input and the one or more control inputs, wherein a maximum forward control input corresponds to the maximum forward speed and a maximum rearward control input corresponds to the maximum rearward speed; generate one or more drive element commands based on the one or more scaled control inputs; and output the one or more drive element commands; wherein the one or more drive elements are configured to be driven based on the one or more drive element commands.

An additional aspect comprises an outdoor power equipment, comprising: a frame; one or more drive elements coupled to the frame; a control unit configured to generate a first steering output based at least in part on one or more control inputs; and a steering system, comprising: a first steerable element coupled to the frame, wherein the first steerable element is symmetric; one or more steering motor controllers configured to receive the first steering output and to generate a first motor control signal based on the first steering output; and one or more steering motors configured to rotate the first steerable element to a first angle based on the first motor control signal.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 provides an illustration of a lawn maintenance apparatus as an example outdoor power equipment employable in connection with various aspects discussed herein.

FIG. 2 illustrates a comparison of front wheels (e.g., driven or non-driven) in a left (top images) zero-turn (a turn with zero or substantially zero turning radius) and right (bottom images) zero-turn for caster wheels (left images) and casterless wheels (e.g., wheels with zero or substantially zero caster trail), according to various aspects discussed herein.

FIG. 3 illustrates a comparison of front wheels (e.g., driven or non-driven) in forward (top images) motion and reverse motion for caster wheels (left images) and casterless wheels (e.g., wheels with zero or substantially zero caster trail), according to various aspects discussed herein.

FIG. 4 illustrates a diagram showing a change in orientation of a steerable wheel, in connection with various aspects discussed herein.

FIG. 5 illustrates two potential types of damping parameter functions (left-hand images) and the effects of the upper left damping parameter function on example control inputs, according to various aspects discussed herein.

FIG. 6 illustrates a pair of flow charts showing a comparison of the generation of vehicle outputs with variable output damping (top flow chart) as compared to without variable output damping (bottom flow chart).

FIG. 7 depicts alternative damping parameter curves as a function of control input(s) and optionally additional parameters, in further disclosed aspects.

FIG. 8 depicts a flow chart of damping parameter curves utilizing operator steering input(s) and vehicle sensor input(s), in another aspect.

FIG. 9 illustrates a diagram showing an example of user inputs to a drive system and the estimated real-world drive system outputs resulting from those inputs, according to various aspects discussed herein.

FIG. 10 illustrates a flow diagram of a technique that can be employed to calculate drive system loss to compensate for drive system loss in steering, according to various aspects discussed herein.

FIG. 11 illustrates drive and steering response of an example rear-drive zero-turning radius (ZTR) vehicle for user inputs and the output commanded to the driving system that would result from the commanded inputs in a hydrostatic drive system according to various aspects discussed herein.

FIG. 12 illustrates an example mechanical/electric system for generating the outputs from operator inputs and an enhanced method for generating an output emulating a hydrostatic system from a mechanical or electric system, according to various aspects discussed herein.

FIG. 13 illustrates a diagram showing a vehicle with a floating neutral point that depends on the slope of the vehicle relative to its facing, according to various aspects discussed herein.

FIG. 14 illustrates a diagram showing operation of a steering system with a static neutral point on level ground, facing uphill, and facing downhill.

FIG. 15 illustrates a diagram showing operation of a steering system with a floating neutral point on level ground, facing uphill, and facing downhill, in accordance with various aspects discussed herein.

FIG. 16 depicts a diagram of vehicle pitch calculation that includes compensation for vehicle acceleration, in another aspect of the disclosed embodiments.

FIG. 17 illustrates a flow diagram showing calculation of steering angle commands based on a floating neutral point, according to various aspects discussed herein.

FIG. 18 illustrates a diagram showing operation of a vehicle employing techniques discussed herein for hill holding and hill speed compensation on level ground (top row), facing uphill (middle row), and facing downhill (bottom row).

FIG. 19 illustrates a flow diagram showing techniques for hill holding and/or hill speed compensation based on vehicle tilt angle, according to various aspects discussed herein.

FIG. 20 depicts a diagram of zero point filtering to mitigate vehicle jerk during a zero or low radius turn in other aspects of the disclosed embodiments.

FIG. 21 depicts a flow chart for zero point filtering adjustment in wheel angle commands for a driven vehicle, in still other aspects of the disclosure.

FIG. 22 illustrates a diagram showing a joystick as an example user input with a mechanical range varying from a neutral position through a forward range and reverse range that can be employed in connection with adjustable top speed techniques discussed herein.

FIG. 23 illustrates images showing example inputs for speed range selection (top left) and control input(s) within a selected speed range (bottom left) and a flow diagram showing control of vehicle speed based on those inputs, according to various aspects discussed herein.

FIG. 24 illustrates a first view of a prototype employing casterless steerable front wheels and other techniques discussed herein.

FIG. 25 illustrates a second view of a prototype employing casterless steerable front wheels and other techniques discussed herein.

FIG. 26 illustrates a third view of a prototype employing casterless steerable front wheels and other techniques discussed herein.

FIG. 27 illustrates an example drive-by-wire control system capable of implementing one or more of the methods or techniques discussed herein.

FIG. 28 illustrates a block diagram of an example control unit operable in conjunction with one or more aspects of the present disclosure.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to providing steering and/or driving control for an outdoor power equipment employing a drive-by-wire system are described herein, it should be understood that the disclosed machines, electronic and computing devices and methods are not so limited and modifications may be made without departing from the scope of the present disclosure. The scope of the systems, methods, and electronic and computing devices for providing drive-by-wire steering and/or driving control are defined by the appended claims, and all devices, processes, and methods that come within the meaning of the claims, either literally or by equivalence, are intended to be embraced therein.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation on the present disclosure. Still further, in the drawings, the same reference numerals are employed for designating the same elements.

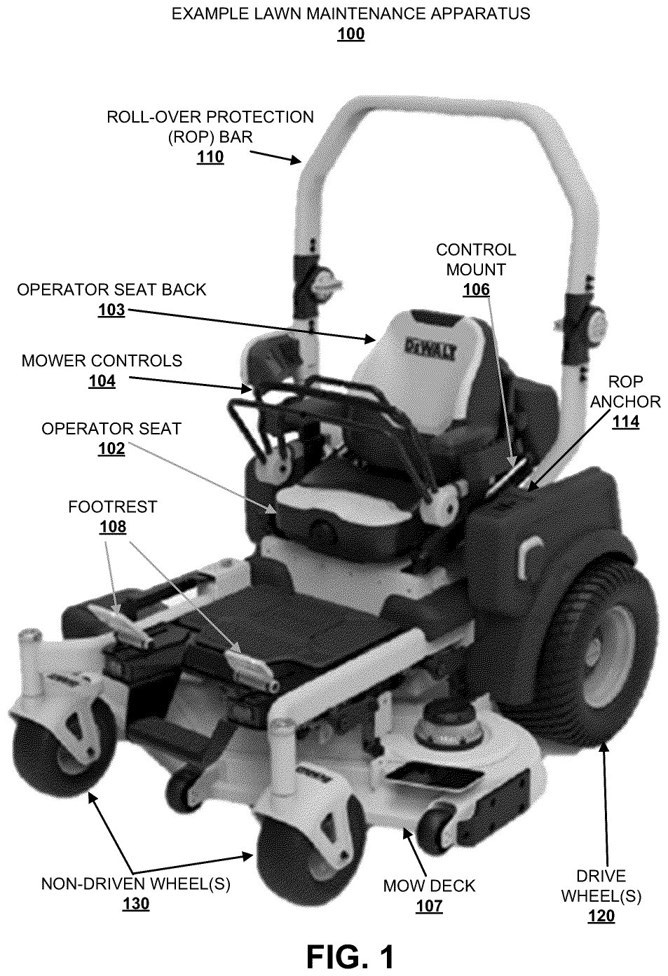

Referring to FIG. 1, illustrated is an example lawn maintenance apparatus 100 comprising non-driven wheels 130, in connection with various aspects discussed herein. Although example lawn maintenance apparatuses (e.g., lawn maintenance apparatus 100) are provided for the purpose of illustrating various aspects discussed herein, various embodiments can be or can be employed within or in connection with other outdoor power equipment (e.g., snow thrower(s), etc.). As illustrated in FIG. 1, lawn maintenance apparatus 100 comprises an operator seat 102 and seat back 103 with mower controls 104 on control mounts 106 for controlling powered operations of lawn maintenance apparatus 100 (e.g., drive functions, steering functions, and so forth, whether mechanical, electro-mechanical, hydraulic, pneumatic, or other suitable means of power operation), as well as electronic control or computer functions of lawn maintenance apparatus 100 (e.g., stored electronic settings, Global Positioning System (GPS) navigation, operator input controls/output indicators, status input controls/output indicators, and so forth). A mow deck 107 is provided beneath a support structure (e.g., frame, etc.) of lawn maintenance apparatus 100, and in the embodiment depicted by FIG. 1, between the front and rear wheels thereof (although this can vary in some embodiments). Example lawn maintenance apparatus 100 also comprises a footrest 108 for operator comfort and a roll over protection (ROP) bar 110 with a ROP anchor point 114 near to a rear wheel rotation axis of lawn maintenance apparatus 100, which can be substantially aligned with an axis of drive wheels 120. In one or more embodiments, ROP anchor point 114 can be within about 6 inches or less of the axis of drive wheels 120.

While for case of illustration a single example embodiment is depicted in FIG. 1, various embodiments can differ from the embodiment depicted in FIG. 1. For example, while FIG. 1 depicts a lawn maintenance apparatus, systems, methods and/or features discussed herein can be employed on different vehicles, such as other types of outdoor power equipment. Additionally, lawn maintenance apparatus 100 is configured for seated operation, but aspects discussed herein can also be employed on vehicles configured for standing operation. Moreover, while on example lawn maintenance apparatus 100, the non-driven wheels 130 shown are dummy caster wheels, various embodiments can additionally or alternatively employ one or more actively steered wheels, including wheels with zero or substantially zero caster trail, such as those shown and described herein as non-caster or casterless wheels. While non-driven wheels 130 are at the front of lawn maintenance apparatus 100, steered non-driven elements (e.g., wheels, skis, tracks, etc.) can be behind drive elements and/or drive elements can also be steered elements. Moreover, in some embodiments, non-wheel drive and/or steering elements can be employed (e.g., tracks, skis, etc.) and driven and/or steered according to various techniques discussed herein.

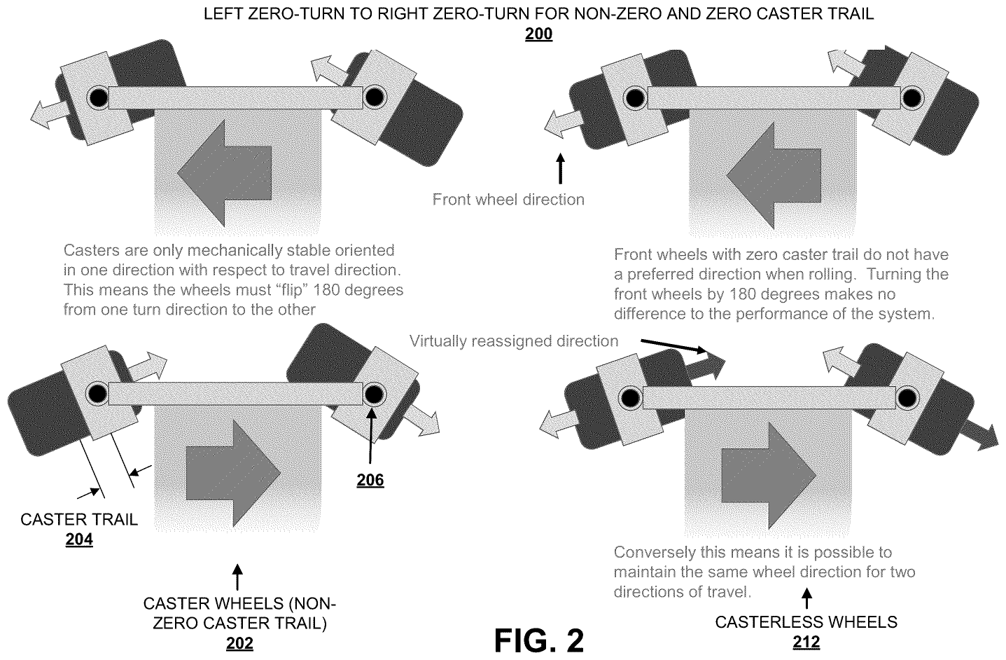

Various embodiments comprise one or more systems, methods, and/or features discussed herein that can facilitate active steering (e.g., of one or more non-drive elements and/or one or more drive elements, etc.), in connection with a drive-by-wire system for an outdoor power equipment such as lawn maintenance apparatus 100. For example, various embodiments can comprise and/or employ one or more of: one or more actively steered non-drive elements (e.g., front/rear wheels, tracks, skis, etc.), which in some embodiments can be steered elements with a preferred orientation such as caster wheels (e.g., with sufficient caster trail such that torque caused by the caster trail can cause rotation of those wheels in normal operation, e.g., see FIG. 2, infra) but in other embodiments can be steered elements without a preferred orientation such as wheels that have zero or substantially zero caster trail (e.g., sufficiently small caster trail that torque caused by the caster trail does not cause rotation of those wheels in normal operation, etc.); one or more actively steered drive elements (e.g., front/rear drive wheels, tracks, etc.); direction reassignment of steered wheels with zero or substantially zero caster trail; employing steering control signal damping (e.g., variable output damping, a deadband, etc.) on the input and/or output of vehicle steering controls—including operator steering controls and computer guidance steering controls—to improve drivability; active steering employing compensation for losses in a drive system for one or more drive elements (e.g., driven wheels, tracks, etc.); emulation of the powered drive operation (e.g., lossiness of response, etc.) of a hydrostatic system in a drive-by-wire steering system; employing a floating neutral point on steering control inputs to improve drivability on surfaces with non-zero pitch (e.g., inclines such as hills, etc.); and/or hill holding and speed compensation (or acceleration compensation) on hills and other surfaces with non-zero pitch. Various embodiments can employ one or more of these systems, methods, and/or features, and the various systems, methods, and/or features discussed herein can be employed in any suitable combination except where otherwise made clear.

As utilized herein, relative terms or terms of degree such as approximately, substantially or like relative terms such as about, roughly and so forth, are intended to incorporate ranges and variations about a qualified term reasonably encountered by one of ordinary skill in the art in fabricating, compiling or optimizing the embodiments disclosed herein to suit design preferences, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic; e.g., a 0 to five-percent variance or a zero to ten-percent variance from precise mathematically defined value or characteristic, or any suitable value or range there between can define a scope for a disclosed term of degree. As examples, a steerable wheel can be turned to a disclosed angle, or substantially the disclosed angle, such as the disclosed angle with a variance of 0 to five-percent or 0 to ten-percent; a disclosed mechanical dimension can have a variance of suitable manufacturing tolerances as would be understood by one of ordinary skill in the art, or a variance of a few percent about the disclosed mechanical dimension that would also achieve a stated purpose or function of the disclosed mechanical dimension. These or similar variances can be applicable to other contexts in which a term of degree is utilized herein such as accuracy of measurement of a physical effect (e.g., a motor speed, a wheel angle, etc.) or the like.

Below, multiple systems, methods, and features employable in connection with various embodiments. Although, for ease of discussion, these are discussed separately, various embodiments can employ or comprise one or more of these embodiments in any suitable combination.

Actively Steered Non-Drive and/or Drive Elements

Embodiments comprising and/or employing actively steered non-drive and/or drive elements (e.g., wheels, tracks, skis, etc.) can employ various techniques discussed herein to improve steering and drivability, such as direction reassignment for casterless wheels (e.g., and/or non-drive/drive elements without a preferred direction, etc.) in appropriate scenarios.

FIG. 2 illustrates a comparison left to right zero turn 200 for caster wheels 202 and casterless wheels 212 in aspects of the disclosed embodiments. For instance, front wheels (e.g., driven or non-driven) are shown in a left (top images) zero-turn (a turn with zero or substantially zero turning radius) and right (bottom images) zero-turn for caster wheels 202 (left images) and casterless wheels 212 (e.g., wheels with zero or substantially caster trail), according to various aspects discussed herein. Caster wheels 202 have a caster trail 204 defined by a distance between an axis of rotation (a rolling axis) of the wheel upon a surface and a pivot axis 206 about which the wheel turns in orientation with respect to the surface (e.g., clockwise or counterclockwise as shown in FIG. 2) and with respect to a frame (or other mounting structure) of a vehicle. Caster wheels 202 are mechanically stable in only one direction of movement at a given time, such that movement of the caster wheel 202 along a surface will cause a torque to rotate the caster wheel such that the wheel will trail behind the pivot axis 206 about which the caster wheel is mounted whenever there is a non-zero angle between the orientation of the caster wheel 202 and the direction of movement (the caster effect).

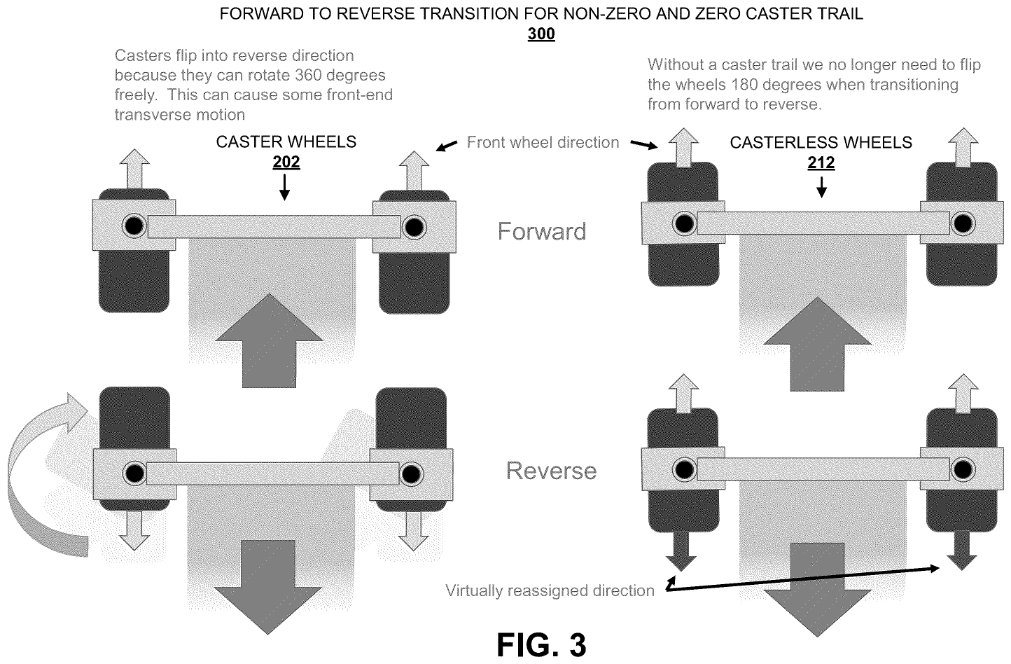

Because of the caster effect, a change in steering of a moving vehicle with caster wheels 202 will cause the caster wheels 202 to rotate to a new mechanically stable orientation. One situation where this can occur is when there is a rapid change in a steering angle of a vehicle in motion, such as changing from a left zero-turn (top left image of FIG. 2) to a right zero-turn (bottom left image of FIG. 2). In such a scenario, the caster wheels 202 will need to reverse their orientation close to 180°, because for wheels with a caster trail 204, there is only one mechanically stable orientation for each direction of travel of the wheel. This re-orientation or flipping of the caster wheels 202 will cause the wheels to pass through intermediate steering orientations when transitioning between a left zero-turn and right zero-turn (or vice versa; see FIG. 3, infra, bottom left). Additionally, for the re-orientation shown in FIG. 2, while the orientation for a left zero-turn is not mechanically stable for a right zero-turn, there is zero or minimal torque provided by the caster effect to reorient the wheel because the wheel is at or very near 180° from the mechanically stable orientation, thus the vehicle cannot readily transition directly from a left zero-turn to a right zero-turn (or any other 180° change in orientation, such as forward to reverse, as discussed below), but may require an operator to pass through intermediate steering angles to apply sufficient torque to re-orient the wheels.

In contrast to caster wheels 202, casterless wheels 212 have zero or approximately zero caster trail 204 and two preferred directions (e.g., forward and reverse, or a first direction approximately 180 degrees opposite a second direction, or the like) when rolling because there is insufficient torque applied via the caster effect to smoothly transition between a non-preferred direction (e.g., one degree to 179 degrees) to a preferred direction (e.g., 0 degrees and 180 degrees). Because of this, casterless wheels 212 are not ideal for situations where the wheels are not actively steered or driven. However, when the wheels are actively steered as in various embodiments discussed herein, casterless wheels 212 can provide superior drivability when compared to wheels with a caster trail 204. Again, considering the scenario of a change from a left-zero turn (top right image of FIG. 2) to a right zero-turn (bottom right image of FIG. 2), it is not necessary for the orientation of a casterless wheel 212 to change between the two turns. Because of this, casterless wheels 212 can maintain the same orientation (e.g., steering angle of the wheel) for two distinct directions of travel of the wheel. As such, in controlling the steering of a casterless wheel 212 in various embodiments, the physical orientation of the casterless wheel 212 (its steering angle) can remain unchanged between a left zero-turn (top right image) and right zero-turn, and this steering angle can be either considered equivalent to or virtually reassigned to the angle appropriate for the new turn.

Various embodiments employing one or more actively steered casterless wheels 212 can provide for independent control of each actively steered casterless wheel 212, such that they can be independently rotated to any suitable angle. For example, one or more disclosed embodiments rotate (e.g., simultaneously in embodiments with more than one wheel, etc.) each wheel (e.g., sometimes in the same direction, sometimes in different directions) to an associated angle commanded for that wheel through a shortest rotational displacement between its current orientation and its commanded angle. Although for the purposes of illustration, active steering and/or direction reassignment techniques are discussed herein in connection with an example of two actively steered wheels, similar techniques can be employed for embodiments that employ non-wheel drive elements that do not have a single substantially preferred orientation, and/or in embodiments with a different number of steerable elements (e.g., one, or three or more).

Referring to FIG. 3, illustrated is a comparison of front wheels (e.g., driven or non-driven) in forward (top images) motion and reverse motion 300 for caster wheels 202 (left images) and casterless wheels 212 (e.g., wheels with zero or substantially zero caster trail), according to various aspects discussed herein.

Considering the caster wheels 202 (left-hand side of FIG. 3), as noted above, the caster trail 204 of the caster wheels 202 causes them to have only one mechanically stable steering angle for a given direction of motion. Thus, when transition from forward to reverse motion 300, the caster wheels will rotate 180° before fully reversing motion, and during the transition, transverse motion of the front end (or whichever end comprises the caster wheels 202) of the vehicle will result as the caster wheels 202 pass through intermediate angles.

In contrast, for casterless wheels 212, each orientation of the wheel is stable for two directions of motion that are 180° apart. Thus, a transition from forward to reverse motion 300 requires no rotation of the casterless wheels, and merely a change in rolling direction about a rolling axis of casterless wheels 212. The steering angle for forward motion can be either considered equivalent to or virtually reassigned to the angle appropriate for reverse motion.

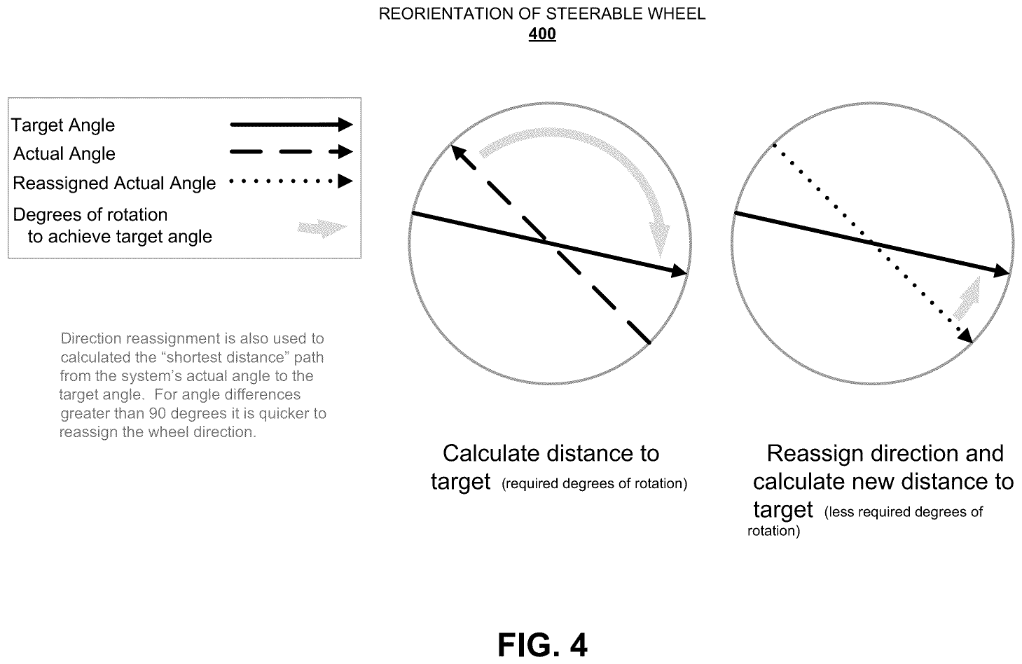

Referring to FIG. 4, illustrated is a diagram showing a change in orientation 400 of a steerable wheel, in connection with various aspects discussed herein. In the left-hand circle, a steerable wheel is oriented along (e.g., and rolling in the direction of) a first direction shown by a dashed arrow, when a change in steering is selected (e.g., based on operator and/or controller input, etc.) to a second direction shown by a solid arrow (e.g., such that if in motion, the steerable wheel will roll in the second direction of the solid arrow). For a caster wheel to become oriented in the new direction, the wheel will rotate through an arc (shown by the curved arrow) until its unique mechanically stable orientation aligns with the solid arrow. However, as shown in the right-hand circle, for a casterless wheel, before the change in orientation to the solid arrow, it has an appropriate steering angle both for motion in the direction of the dashed arrow, but also in the opposite direction (as shown in the dotted arrow in the right-hand circle of FIG. 4). In various embodiments, either of these two orientations can be selected for the casterless wheel. For the transition from the dashed to solid arrows as shown in the left circle, the degrees of rotation through the reorientation arc (e.g.,) X° will exceed 90° (X°>) 90°. Thus, in various embodiments, the orientation of the casterless wheel can be considered equivalent to or reassigned to the opposite direction, as shown in the right-hand circle of FIG. 4, such that the casterless wheel can be rotated through a smaller arc of (180-X)° to be reoriented in the correct direction for the change in steering.

In embodiments comprising and/or employing steerable casterless wheels (e.g., drive wheels and/or non-drive wheels), direction reassignment can occur as follows. First, upon receiving a change in steering to a target angle, a difference angle between a current steering angle) (C° and the target steering angle) (T° can be calculated (e.g., by subtracting the smaller angle from the larger, taking an absolute value of a difference, etc.), X°. A determination can be made whether or not the difference angle is greater than 90°. If the angle X° is not greater than 90°, the casterless wheel can be rotated from the current steering angle C° to the target steering angle T°. Otherwise (when the angle X°>) 90°, the current angle) (C° can be reassigned to its opposite (e.g.,) (180±C)°, which can then be rotated (180-X)° (which is less than 90°, because X°>90° to be oriented in the correct direction for the change in steering to the target steering angle T°. Thus, the casterless wheel can always be rotated no more than 90° for a change in steering, regardless of the difference between the new and old directions of motion and/or steering angles.

While the above discussion specifically describes operation of casterless wheels (which do not have a preferred direction) with caster wheels (which have a preferred direction), similar techniques (e.g., direction reassignment, etc.) can be employed with other non-wheel drive and/or non-drive element(s) that are either symmetric or substantially symmetric in operation (e.g., element(s) that do not have a single preferred or strongly preferred direction or orientation, but can slide, roll, etc. substantially equally well in two directions substantially 180° from each other, etc.).

### Variable Output Damping

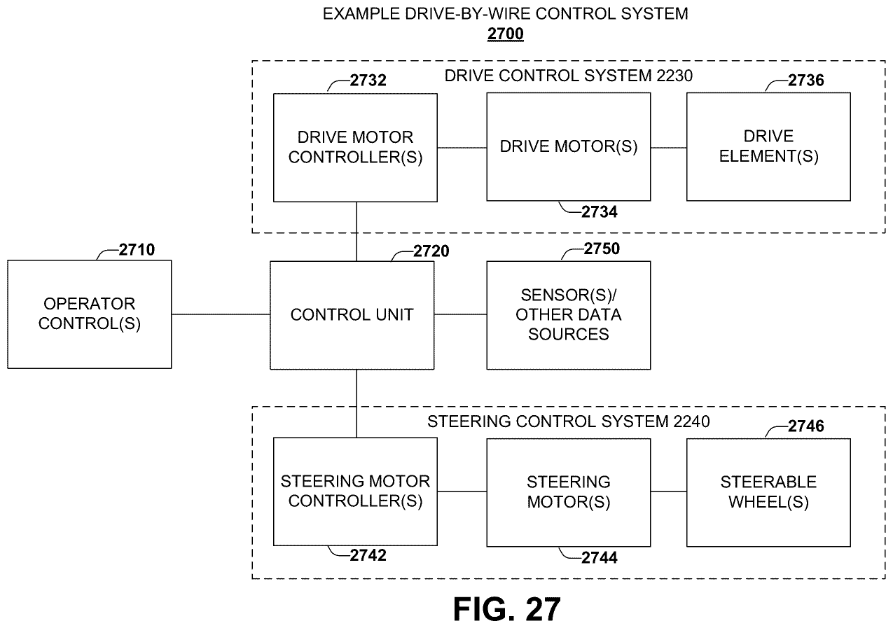

Various embodiments can employ variable output damping to steering output signals generated by a controller of a vehicle in response to a drive or steering control input(s). The drive or steering control input(s) can be an operator-provided input(s) via local or remote operator controls (for manual and/or semi-autonomous operation) and/or from a control unit (for manual, semi-autonomous, and/or autonomous operation, such as generated by a control unit in connection with an autonomous driving algorithm, etc., for instance, see control unit 2720 of FIG. 27, infra). The variable output damping of steering output signals can improve drivability by making vehicle control outputs (e.g., drive element (e.g., rear wheel, etc.), drive system commands, steerable element (e.g., front steerable wheel(s)) steering angle commands, and/or similar drive/steering/movement output commands, etc.) less sensitive to rapid fluctuations in pre-damping or undamped control output values and less sensitive to noise, particularly when the control inputs are very small.

Variable output damping can be employed as an alternative to using a deadband on the input and/or output of the vehicle controls, where a level of damping can be calculated based on various factors and then can be applied to the output controls. The damping level varies based on the input's proximity to zero/neutral. The present disclosure can utilize one or more output damping functions to generate control signal outputs utilized for steering a vehicle. The control signal outputs can be steering angles in the example of steered wheels, or can be relative drive speeds in the example of steering implemented with differing drive wheel speeds. These output damping functions can include parameters that themselves are functions of control input, vehicle speed, engine rpm, mapping between operator control input and vehicle speed, or the like, or a suitable combination of the foregoing. Examples of the suitable output damping functions are described in more detail hereinafter.

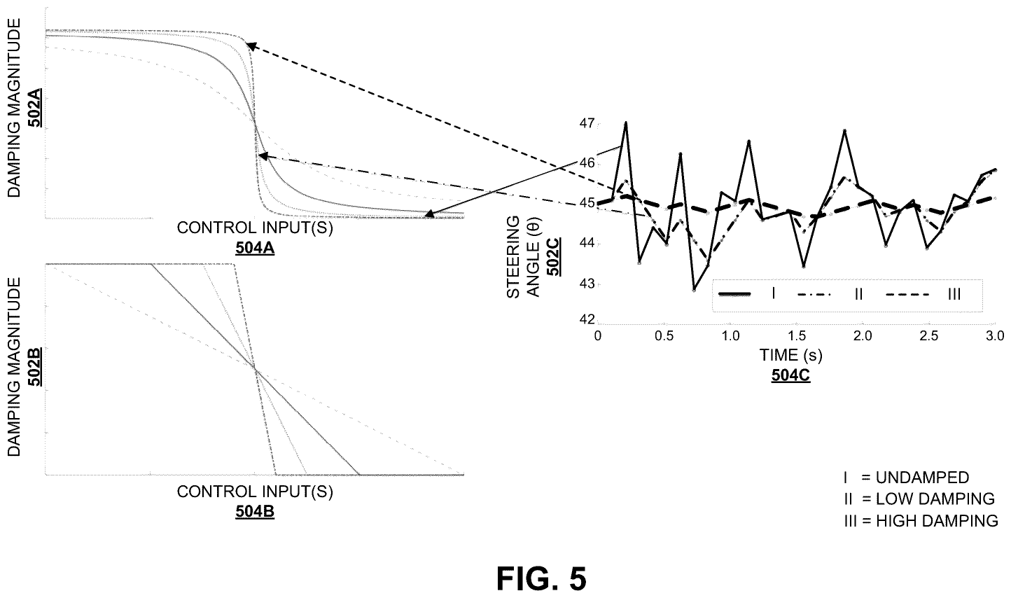

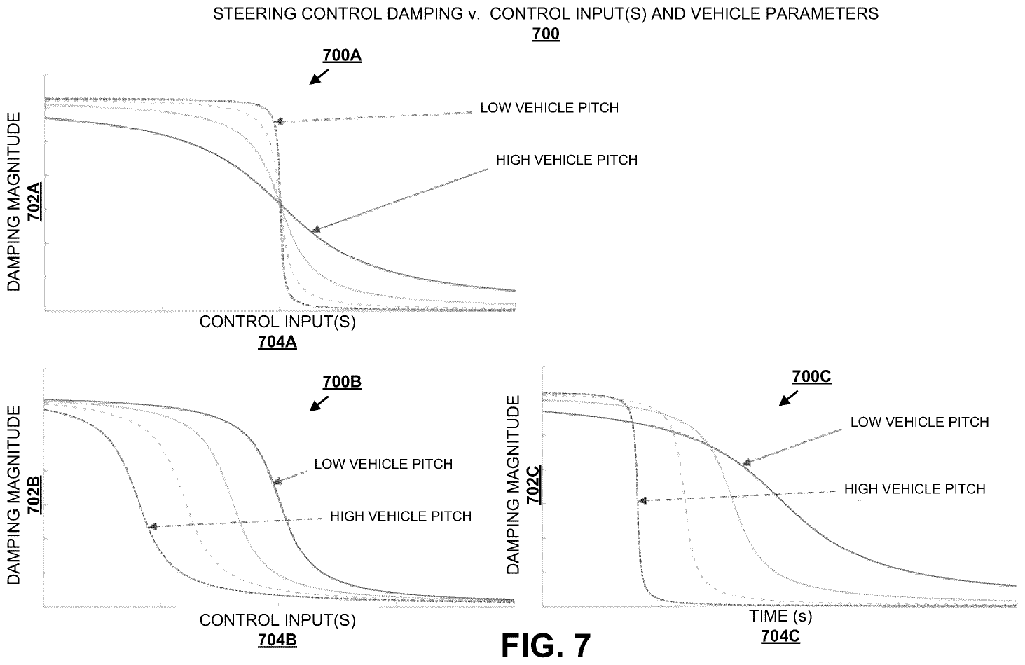

FIG. 5 illustrates two potential types of damping parameter functions (left-hand graphs). The graph on the right illustrates the effects on steering angle of a steerable wheel(s) that corresponds to the effects of three different damping parameter values on example steering/drive control inputs for one of the damping parameter curves of the upper left graph. The left-hand graphs of FIG. 5 provide a general illustration of a few example damping parameter curves (see also FIGS. 7, infra), with high values on the plot indicating significant damping and low values indicating very little damping.

In general, embodiments employing variable output damping can incorporate damping parameter functions defining a damping magnitude that is a generally decreasing function of increasing control input (e.g., steering angle input), such that the output is the control input as reduced by the damping level, which ranges from a maximum damping level (at small, including zero, input) to a minimum damping level (at larger input(s)). The top left graph shows a family of smoothly decreasing damping parameter functions that can be applied for variable output damping. The bottom left graph shows a family of piecewise linear damping parameter functions (each of which has three distinct segments) that can be applied for variable output damping, where a maximum level of damping can be applied for a first range (which can be zero) of small control inputs starting at a minimum (zero) input, linearly decreasing damping can be applied for a second range (which can be zero) of control inputs greater than the first range of inputs, and a minimum level of damping can be applied for a third range (which can be zero) of larger control inputs greater than the second range of inputs, as long as partial damping is applied for at least one or more input values. While four example members of each family of functions is shown in each of the left-hand graphs, these are solely for purposes of example, and substantially any suitable damping according to the family of functions of each graph can be employed, as can any other suitable damping function that is generally decreasing and decreases from a maximum output damping at small (including zero) control input to a distinct and lower minimum output damping at larger control inputs (e.g., a function that meets these criteria can be employed for variable output damping in various embodiments). Additionally or alternatively, variable output damping can be applied based on other criteria, such as a moving average filter where the extent of damping depends on the magnitude of changes in inputs instead of the magnitude of the inputs.

It is noted that the limit case of both families of functions shown in the upper and lower left-hand graphs as the middle becomes increasingly steep can be a deadband function wherein inputs below a threshold are fully damped and those above the threshold are undamped. While embodiments employing other aspects discussed herein can employ a deadband, variable output damping as discussed herein is distinctive from employing a deadband as discussed in greater detail below, and can result in at least some inputs which are partially but not fully damped.

The right-hand graph of FIG. 5 illustrates the effect of three damping parameter values for the steepest damping parameter curve of the upper left-hand graph on the control input values, which in this example is the steering angle output signal of a steering mechanism. The (substantially) undamped line (solid line denoted line I in the legend) corresponds to a damping parameter value of zero (or substantially zero) and therefore depicts the raw steering angle output signal value, including associated noise. The other two lines show the same steering angle output signal with low damping parameter value (dashed and dotted line denoted line II) and high damping parameter value applied (dashed-only line denoted line III). The arrows between the upper left-hand and right-hand graphs correlate the respective damping parameter values of the steepest damping parameter curve to the respective steered wheel output angles. Different values of control input result in different levels of damping on the output values.

In various embodiments, disclosed damping parameter functions and control signal inputs can be utilized as respective inputs to an output damping function, to achieve variable output damping. Output damping functions can include smoothing functions that moderate a rate of change between control signal inputs (e.g., received from an operator steering mechanism) and corresponding control output signals sent to a steering mechanism. Some examples of output damping functions include: (1) a low-pass filtering function with alpha value varied by a suitable damping parameter function (e.g., see FIGS. 7, infra, for an example alpha damping parameter function); (2) moving average filtering with a number of data points determined by an associated damping parameter function; (3) slew rate control with a slope limit determined by an associated damping parameter function; and others. Example damping parameter functions for these smoothing functions include those depicted in FIGS. 5 and 7, and described herein. In various techniques, the value of the control input(s) (e.g., current and/or most recent X inputs, current and several recent X inputs, etc.) can be used together with the damping parameter function value(s) to produce a control signal output.

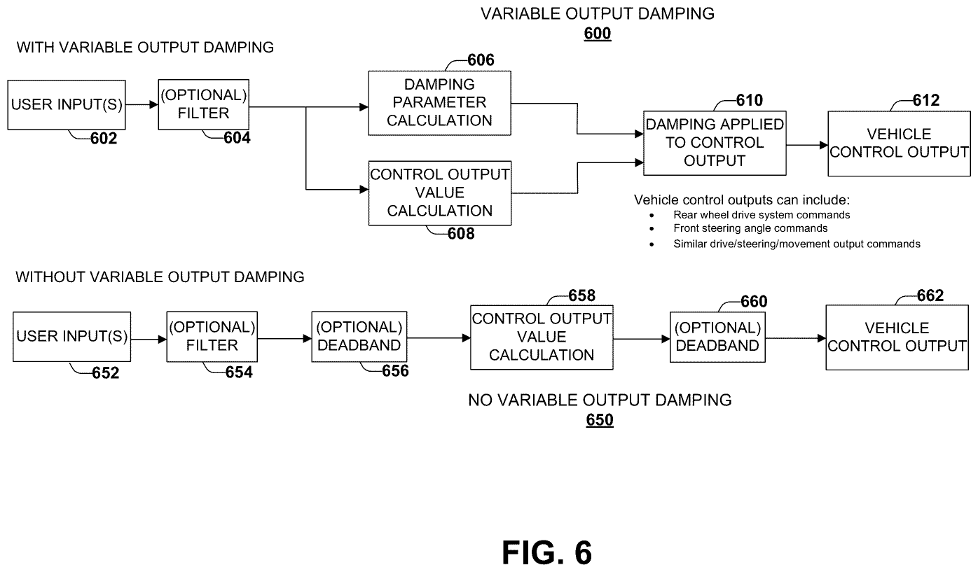

Referring to FIG. 6, illustrated is a pair of flow charts showing a comparison of the generation of vehicle control outputs with variable output damping (top flow chart) as compared to without variable output damping (bottom flow chart) such as employing a deadband, no damping, etc. In variable output damping, a damping parameter(s) is calculated based on control inputs (e.g., current and/or historic such as the most recent N inputs at a given sample rate) and the damping is then applied to calculate control outputs.

In variable output damping, shown in flow 600, user and/or other control inputs (e.g., local user inputs, remote user inputs, inputs generated via an autonomous and/or semi-autonomous driving/steering program, etc.) can be received at 602, for any of a variety of suitable vehicle functions.

Optionally, at 604, filtering according to any of a variety of suitable filters can be applied to the input(s).

At 606, one or more damping parameters can be calculated based on the inputs (either directly or optionally filtered at 604), for example, according to suitable damping parameter functions discussed herein.

At 608, a control output value can be calculated based on the inputs (either directly or optionally filtered at 604). This control output value will not be the final output sent to the steering and/or drive controls, but what it would be absent variable output damping.

At 610, the damping parameter(s) calculated at 606 and the control output value calculated at 608 can be provided to an output damping function, and a damped control output value can be generated.

At 612, the damped control output value can be employed as the vehicle control output for the given system (e.g., drive system command, steering angle command, etc.).

In contrast, a scenario without variable output damping is shown in flow 650. At 652, similarly to 602, user (and/or other) inputs can be received, for any of a variety of suitable vehicle functions.

Optionally, at 654 (similarly to 604), filtering can be applied to the input(s).

At 656, a first deadband (e.g., an input deadband) can optionally be applied to the user inputs as optionally filtered at 654.

At 658, a control output value can be calculated, either directly from the user inputs of 652, or as optionally filtered at 654 and with optional application of the first deadband of 656.

At 660, a second deadband (e.g., an output deadband) can optionally be applied to the calculated control output value of 658. Depending on different aspects of the disclosed embodiments, no deadband is applied, only the first deadband is applied, only the second deadband is applied, or both the first and second deadbands are applied.

FIG. 7 illustrates a set of graphs depicting example damping parameter curves versus control input(s) for one or more vehicle parameters, according to one or more additional embodiments of the present disclosure. In addition to damping parameter value varying based on (steering) control input, the damping parameter value can vary as a function of a measured parameter(s) associated with a vehicle in addition to the control input. Example measured parameters can include a vehicle kinetic parameter(s) (e.g., speed, acceleration, rotational acceleration, etc.), a vehicle orientation parameter(s) (e.g., pitch, roll, yaw, among others), a vehicle operation parameter(s) (e.g., engine rpm, implement rpm, and others), or the like, or suitable combinations thereof. As one example, a measured vehicle orientation parameter can be a pitch angle of a vehicle with respect to the gravitational vector of the Earth. In another example, a measured vehicle operation parameter can be a rotation per minute (rpm) of a prime mover of the vehicle (e.g., an engine, a motor, etc.). As introduced previously, a function that defines the control output damping magnitude (e.g., a smoothing function) can have a parameter(s) that varies with the control input and with the measured vehicle parameter(s). For example, a slope of a damping parameter function can vary with the measured parameter(s) of the vehicle. In another example, an offset of the damping parameter function can be determined from the measured parameter(s) of the vehicle. In yet another example, both the slope and the offset of the damping parameter function can be determined from the measured parameter(s) of the vehicle.

FIG. 7 provides illustrative damping parameter functions 700, utilized for calculating parameter inputs for disclosed output damping functions, and is not intended to limit the suitable output damping functions that are within the scope of the present disclosure. Other damping parameter functions that depend on control input and/or measured vehicle parameter are also within the scope of the present disclosure. Graph 700A depicts damping parameter values 702A having a slope that depends on vehicle pitch. Graph 700B depicts damping parameter values 702B having an offset parameter that depends on vehicle pitch (and having constant slope). Graph 700C depicts damping parameter values 702C having both the offset parameter and slope depending on vehicle pitch. As described previously, different damping parameter functions can be utilized in which other damping parameter function variables vary with other measured vehicle parameters. In some aspects of the disclosed embodiments, a damping parameter function can be an inverse tangent function (or, e.g., a negative inverse tangent function). In at least one aspect, the inverse tangent function can have the form of:

y=−(1/pi)*atan(m*(x−b))+½

where x is the control input, y is the damping magnitude, m is a first function of: vehicle pitch, engine rpm, vehicle speed, a correlation between operator control input to vehicle speed, or a combination thereof, and b is a second function of the vehicle pitch, engine rpm, vehicle speed or correlation between operator control input to vehicle speed, or a combination thereof. In some aspects, the first function defining m can be the same as the second function defining b, whereas in other aspects, the first function defining m can differ from the second function defining b. In one or more aspects, the first function defining m can vary linearly with a measured sensor parameter of the vehicle. Similarly, the second function defining b can vary linearly with a measured sensor parameter of the vehicle.

Disclosed control output damping functions can depend on engine RPM in some aspects of the disclosed embodiments. For instance, changes in engine RPM can directly affect the correspondence between control input and vehicle speed, and thus engine RPM can be used as a proxy for vehicle speed in one or more aspects of the disclosed embodiments. Disclosed control output damping functions can apply high damping on control output (e.g., steering angle commands, etc.) when vehicle speed is zero or near to zero. The control output damping decreases as the vehicle speed increases. Depending on the type of vehicle and drive and steering controls provided for the vehicle, control input signal magnitude required to increase vehicle speed can depend on engine RPM, and vehicle speed responsiveness (or how quickly vehicle speed increases/decreases with increased/decreased control signal input) can also depend on engine RPM. For example, in response to lower engine RPM, a control input can require relatively high input signal magnitude to increase vehicle speed above zero, and vehicle speed increases more slowly in response to increasing input signal magnitude with low engine RPM. To offset this effect, a control output damping function can be configured to reduce damping magnitude as control input level increases (e.g., an increase in value of b: the control input shift parameter) to align the damping parameter function with vehicle motion.

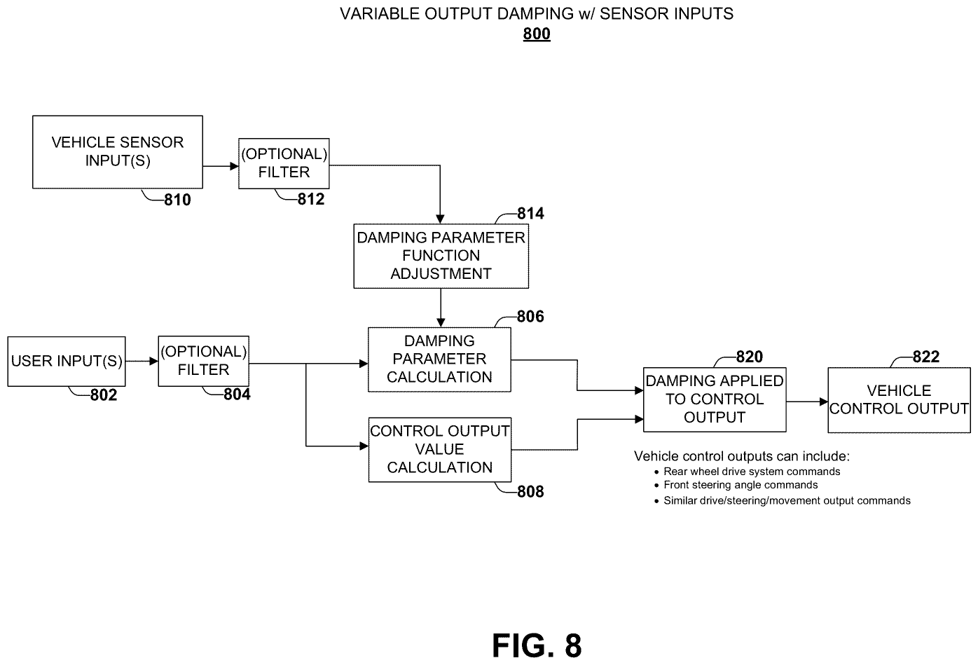

FIG. 8 depicts a flowchart of an example method 800 for implementing variable output damping incorporating measurements of vehicle sensors, in one or more aspects of the disclosed embodiments. At 802, method 800 can comprise receiving a control input. The control input can be drive and/or steering input from an operator steering and/or drive mechanism, an operator's remote control drive and/or steering input, or an autonomous or semi-autonomous drive and/or steering input from a computer controller of the autonomous or semi-autonomous drive and/or steering input. At 804, an optional filtering algorithm can be applied to the received control input, as described throughout this specification. At 806, method 800 can comprise calculating a damping parameter value, and at 808 method 800 can comprise calculating a control output value for a steering and/or drive system. Calculation of the damping parameter value can incorporate a damping parameter function adjustment, as described below.

At 810, method 800 can comprise receiving a vehicle sensor input(s). The vehicle sensor input(s) can be a vehicle orientation sensor input, a vehicle operation sensor input, a vehicle kinetic sensor input, or the like, or a suitable combination of the foregoing. At 812, method 800 can optionally apply a filter algorithm to the received vehicle sensor input(s). At 814, method 800 can comprise determining a damping parameter function adjustment in response to the vehicle sensor input(s). The damping parameter function adjustment can be an adjustment to an offset parameter of the function, an offset of a slope parameter of the function, an offset to a quadratic (e.g., second order) parameter of the function, or other parameter of the function. In alternative or additional aspects, the adjustment can be an adjustment to a control output shift parameter, a control output scale parameter, or the like, or suitable combinations of the foregoing.

At 820, method 800 can comprise applying the calculated damping parameter to the calculated control output value. At 822, method 800 can then comprise generating and outputting the vehicle control output signal.

### Drive System Loss Compensation Steering

Various embodiments can employ techniques for drive system loss compensation to steering outputs (e.g., via open loop techniques discussed herein, etc.). These techniques can be employed in a variety of systems, such as those employing mechanical and/or hydrostatic drive systems, those employing electric and/or electronic drive systems, etc. In various embodiments, drive system loss compensation techniques can employ an algorithm that can characterize the response of an open-loop drive system and predict the state of the outputs based on the inputs.

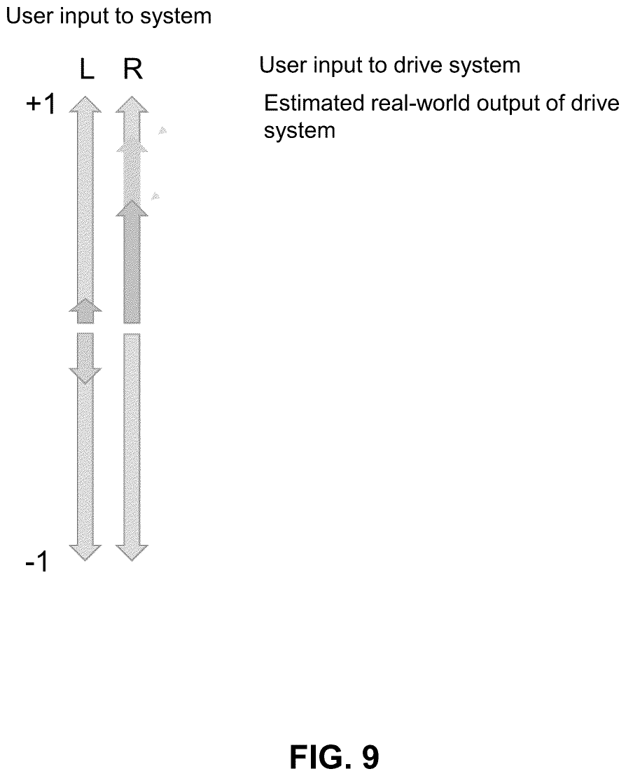

Referring to FIG. 9, illustrated is a diagram showing an example of user inputs to a drive system and the estimated real-world drive system outputs resulting from those inputs, according to various aspects discussed herein. The inputs can be provided via a variety of potential control systems (e.g., lap bar, single axis joystick(s), dual axis joystick(s), etc.) to left and right drive output elements (e.g., left and right drive wheels, tracks, etc.). In FIG. 9, +1 and −1 indicate maximum forward and reverse inputs, respectively. FIG. 9 shows example user inputs to the drive system (nearly maximum forward input to the right drive element(s) and a lesser magnitude rearward input to the left drive element(s)). In a variety of vehicles (e.g., hydrostatic drive system vehicles, electric drive system vehicles emulating the behavior of hydrostatic drive system vehicles, etc.), the resulting drive system outputs from these inputs can differ significantly from the inputs for example, as shown in FIG. 9, resulting in forward motion of both left and right drive elements, with the right drive elements moving faster.

In FIG. 9, two inputs independently control two outputs (e.g., left and right drive wheels). However, due to the interaction of these outputs through the vehicle dynamics, the actual output speeds of each wheel differ from a direct correlation to the respective input. Understanding this difference allows for prediction of the true behavior of the vehicle based on just input values to the system.

This loss approximation can be employed to facilitate predicting system output(s) when limited sensor data is available (e.g., when only inputs to the drive system are known and feedback for the output of the system is not measured, etc.). These techniques can also be used in various embodiments to modify drive commands to a system to improve drivability.

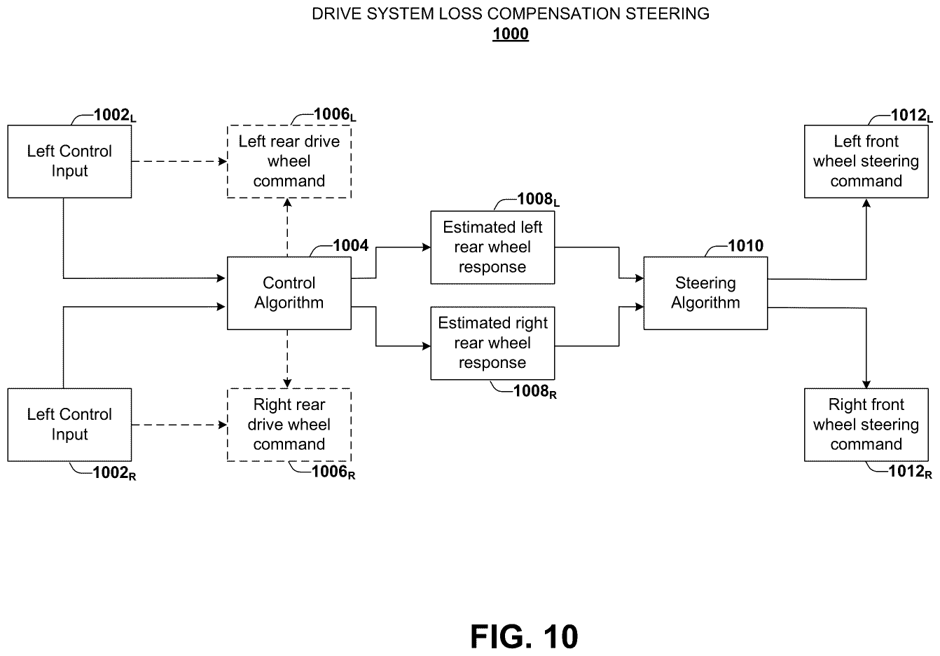

Referring to FIG. 10, illustrated is a flow diagram 1000 of a technique that can be employed to calculate drive system loss to compensate for drive system loss in steering, according to various aspects discussed herein. Flow 1000 as depicted in FIG. 10 applies to drive systems that are inherently lossy, such as a hydrostatic transmission system, but variations on flow 1000 for other drive systems (e.g., electric systems simulating hydrostatic transmission drivability, etc.) are also discussed below. Additionally, although not shown in FIG. 10, similar techniques can be employed (e.g., in vehicles with electric drive systems, etc.) to calculate the drive system loss that would occur in a similar vehicle with a different drive system (e.g., employing hydrostatic transmissions) to determine drive system outputs to simulate the drivability of that similar vehicle with a different drive system.

At 10021 and 1002R, left and right control inputs can be received, for example, from left and right control inputs (e.g., lap bar, etc.) respectively, from an autonomous or semi-autonomous driving algorithm, etc.

In some embodiments, the left and right user inputs can directly control left and right drive elements, respectively (e.g., in embodiments employing mechanical connections between operator controls and hydrostatic transmissions, etc.), and left and right drive element commands 10061 and 1006R can be omitted. In some other embodiments, the left and right user inputs can be used to generate left and right drive element (e.g., rear drive wheel, etc.) commands 10061 and 1006R, respectively (e.g., in some drive-by-wire embodiments, etc.). In still other embodiments, a control algorithm (e.g., 1004) can generate a left drive element command 1006L based on both the left and right control inputs and can generate a right drive element command 1006R based on both the left and right control inputs.

At 1004, a control algorithm can receive the left and right control inputs, which can be used to estimate drive element responses and in some embodiments to generate left and right drive element commands, 1006L and 1006R, respectively. These commands can be determined based directly on user or other control inputs, or can employ other techniques discussed herein (e.g., variable output damping, etc.). In an inherently lossy system, the determined drive element commands can be provided to the drive elements to control the drive system. In systems simulating such drive systems, however, other commands can be provided to drive elements, as discussed below.

Based on the combination of the left and right drive wheel commands determined by the control algorithm at 1004, at 1008L and 1008R, estimated left and right drive element responses can be determined. In a lossy system such as a hydrostatic transmission system, these can be estimations of the actual output response of the left and right drive elements. In a less lossy system (e.g., electric, etc.), these can be estimations of what the actual output responses would be in the lossy system being emulated. In such systems, these estimations (1008L and 1008R) can be output to the left and right drive systems, respectively, to emulate operation of the lossy system.

At 1010, the left and right drive element responses estimated at 1008L and 1008R, respectively, can be provided to a steering algorithm to determine the effective steering associated with those drive element responses.

Based on what that effective steering is (and other considerations, such as the location of steerable wheels relative to the center of rotation, etc.), left and right steering commands can be determined at 10121 and 1012R for left and right steerable wheels, respectively.

Various embodiments can employ the above techniques to estimate drive-wheel (track, etc.) speed on an open-loop system based on user input position(s). One example is a system which includes hydrostatic transmissions coupled to lap-bar inputs, although these techniques can also be employed in connection with other input devices (e.g., joystick(s), etc.) and other drive systems (e.g., electric/electronic drive systems seeking to improve drivability, such as discussed in greater detail herein).

### Hydro Loss Emulation Drive System

Various embodiments can employ techniques to emulate the drive system response of a lossy or open-loop drive system (e.g., a drive system employing hydrostatic transmissions, etc.) in a drive system with minimal lossiness and/or closed-loop feedback control or similar (e.g., electric/electronic drive systems, etc.).

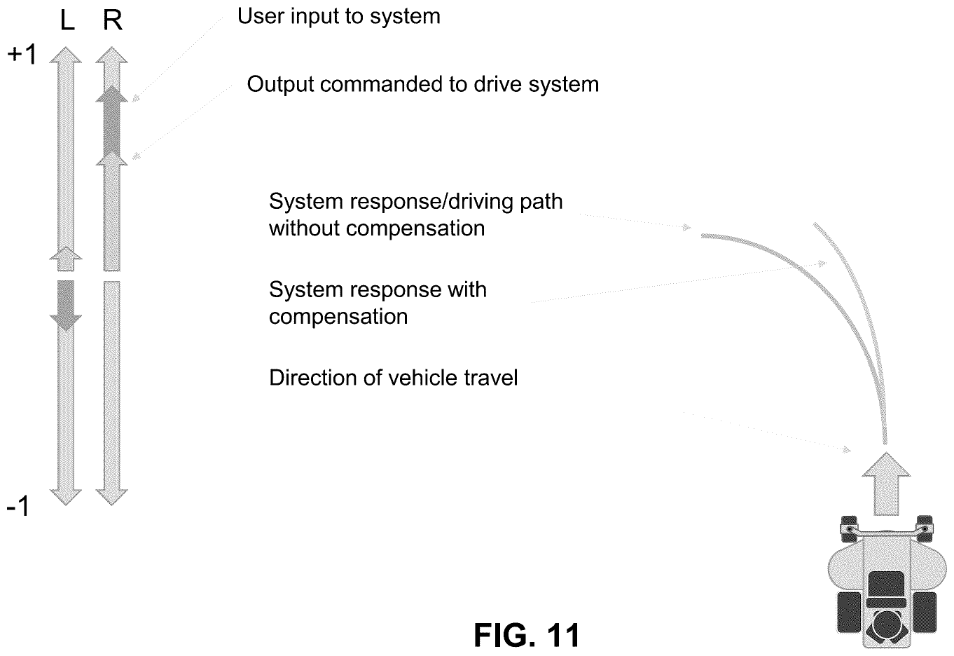

Referring to FIG. 11, illustrated is a diagram showing the user inputs and outputs shown in FIG. 9 on the left-hand side, along with the drive and steering response of an example rear-drive zero-turning radius (ZTR) vehicle for the user inputs to the system (blue arc) and the output commanded to the driving system (green arc) that would result from the commanded inputs in a lossy or open-loop drive system (e.g., employing hydrostatic transmissions, etc.) according to various aspects discussed herein. In a lossy drive system, the blue arc would not result given the blue inputs. However, in minimally lossy or closed-loop feedback control drive systems (e.g., electric/electronic, etc.) providing the user inputs (blue arrows) to the drive systems will result in the blue arc, which provides for much tighter steering than the green arc, which users may find difficult to operate.

In various embodiments, techniques discussed below can be employed in connection with lossless drive systems (e.g., electric) to emulate a lossy drive system (e.g., hydrostatic), which can improve drivability and user comfort.

Hydrostatic drive systems are generally considered to provide superior user comfort and vehicle drivability experience when compared with other drive systems. The drivability experience of a hydrostatically driven vehicle is partially due to a lossy response to the user inputs that usually occurs by nature of the hydrostatic transmissions used in the vehicle. In various embodiments, this response can be emulated with other drive systems. Techniques discussed below employ an algorithm that allows an electrically driven vehicle (e.g., battery-electric, hybrid-electric) to emulate a hydrostatic drive system to improve the drivability of the vehicle with the electric drive system.

A variety of vehicles have two (left and right) operator controls (e.g., dual lap bars, dual joysticks, etc.) that are used to control the speed and direction of each corresponding drive element independently. Techniques discussed below can determine the speed and direction for each drive element using an interdependent combination of user inputs instead of just the corresponding input alone, resulting in an adjustment to the turning radius of the vehicle.

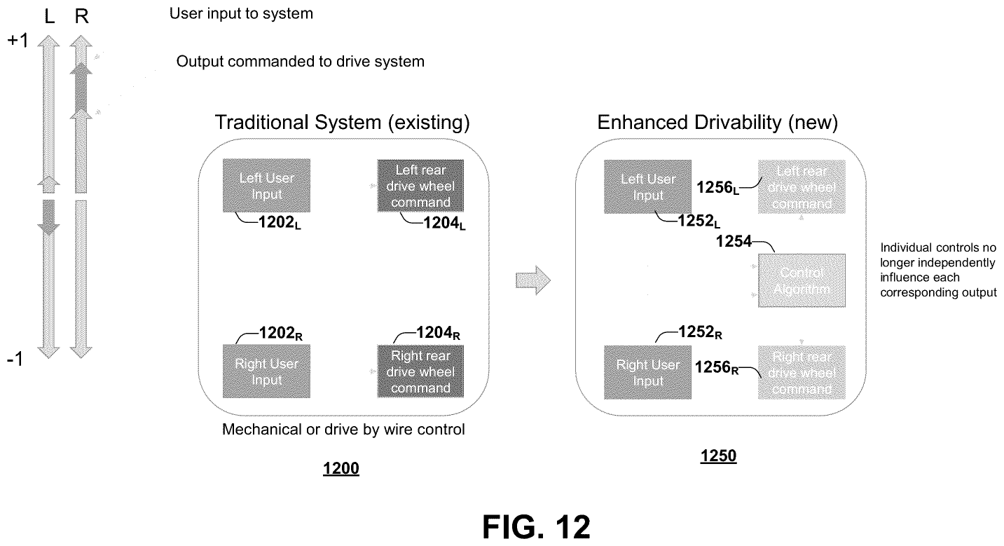

Referring to FIG. 12, illustrated is a diagram showing the user inputs and outputs shown in FIG. 9 on the left-hand side, along with a mechanical/electric system for generating the blue output curve of FIG. 11 (left-hand flow 1200) and an enhanced method for generating an output emulating a hydrostatic system from a mechanical or electric system (right-hand flow 1250), according to various aspects discussed herein.

Flow 1200 shows that in existing mechanical or electrical systems, the left user input 1202L is used to generate the left drive element (e.g., wheel) command 1204L, and the right user input 1202R is used to generate the left drive element (e.g., wheel) command 1204R. In such a system, these commands are calculated independently from each other, with both the magnitude and direction of each output being independent of the other side's input.

In flow 1250, however, both the left control (e.g., user, etc.) input 1252L and the right control input 1252R are provided to a control algorithm 1254 that calculates both the left drive element (e.g., wheel) command 1256L and the right drive element command 1256R. In flow 1250, the left drive element command 1256L depends on both the left control input 1252L and the right control input 1252R, and the right drive element command 1256R also depends on both the left control input 1252L and the right control input 1252R.

By taking both control inputs into consideration, control algorithm 1254 can calculate outputs that allow an electric unit to simulate a gas/hydrostatic unit instead of separately controlling each output with a single input. This gives an electric unit driving behavior that emulates that of a vehicle employing hydrostatic transmissions, which is generally preferred by users.

### Floating Neutral Point

Various embodiments can employ a floating neutral point in connection with drive-by-wire vehicle drive and/or steering systems, wherein the neutral point(s) of the user (or other control) input(s)—position(s) of the input control(s) that are considered as providing no input—can be redefined based on various factors, such as a slope on which the vehicle is located.

Various embodiments employing drive-by-wire systems can employ a floating neutral point, which can be shifted to a software defined “neutral” position of the user input(s) away from the mechanical neutral position, for steering calculations. Control inputs at this shifted neutral position would result in an estimated speed of zero based on a measured vehicle pitch angle. Front wheel steering angles can be calculated based on the shifted neutral position.

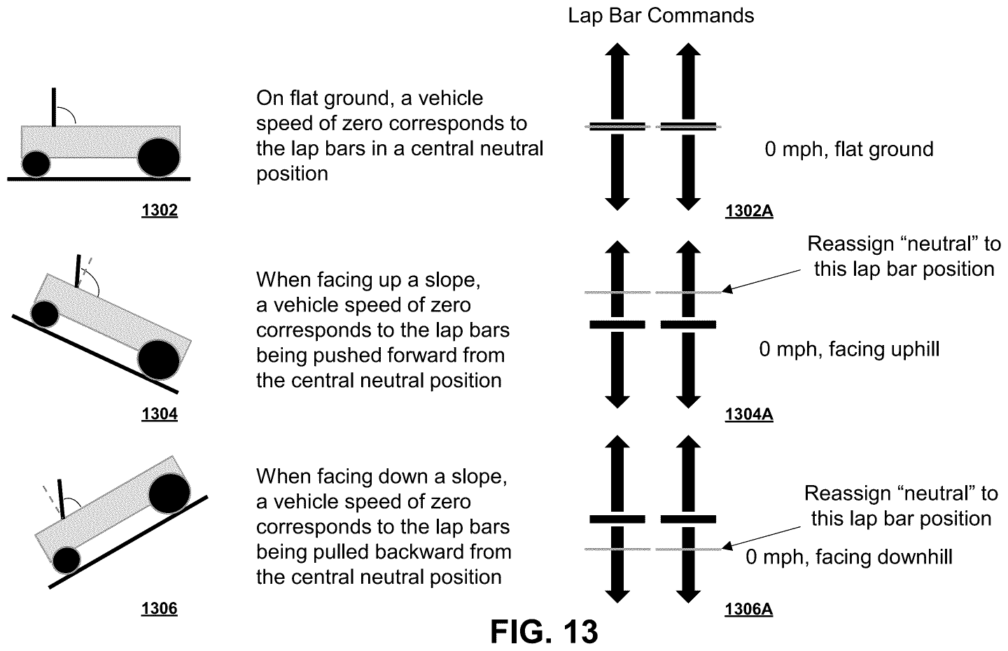

Referring to FIG. 13, illustrated is a diagram showing a vehicle with a floating neutral point that depends on the slope of the vehicle relative to its facing, according to various aspects discussed herein. On the top row, a vehicle with a floating neutral point is on flat ground 1302, where the vehicle speed of zero corresponds to a neutral position for user input(s) (e.g., lap bars, etc.), thus the floating neutral point can correspond to the mechanical neutral point for such scenarios. On the middle row, with the same vehicle facing up a slope 1304, a vehicle speed of zero corresponds to operator input(s) being pushed forward from the mechanical neutral position by an amount that depends on the slope, thus the floating neutral point would correspond to the positions of the input(s) displaced forward that corresponds to a vehicle speed of zero. On the bottom row, where the same vehicle is facing down a slope 1306, a vehicle speed of zero corresponds to operator input(s) being pulled backward from the mechanical neutral position by an amount that depends on the slope, thus the floating neutral point would correspond to the positions of the input(s) displaced backward that corresponds to a vehicle speed of zero.

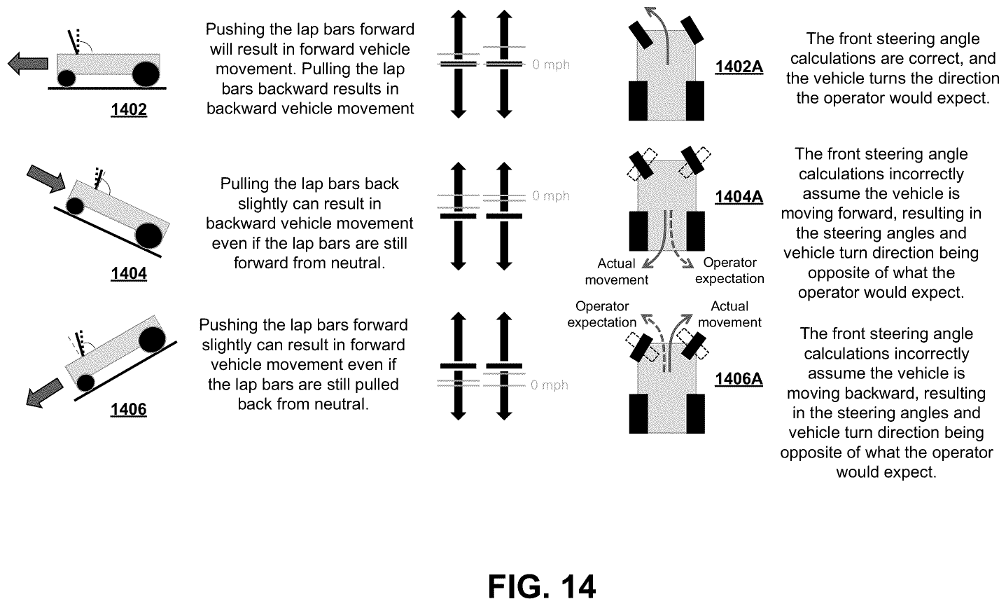

This redefinition of the neutral point for the purposes of steering output calculations can fix counterintuitive operation of the steering system that would otherwise result were the neutral point used for the purposes of steering determinations fixed at the mechanical neutral position. Referring to FIG. 14, illustrated is a diagram showing operation of a steering system with a static neutral point on level ground, facing uphill, and facing downhill. While specifically showing and discussing a scenario involving lap bar inputs, the steering outcomes will also occur with other input devices (e.g., single or dual axis joystick(s), etc.).

The top row of FIG. 14 shows example inputs and steering response when operating a vehicle with a static neutral point on level ground. Pushing both lap bars forward results in forward movement, pulling both back results in backward movement, and pushing them both forward by different amounts results in a correct steering response, where the vehicle turns in an expected direction, turning in an arc toward the side with the lesser input.

The middle row of FIG. 14 shows example inputs and steering response when operating a vehicle with a static neutral point facing uphill. Pulling the lap bars backward slightly from the point associated with zero speed (between the static neutral point and the point associated with zero speed) can result in backward vehicle movement even if the lap bars are still forward of neutral. With the static neutral point, however, turning when facing uphill can provide incorrect steering angles. If the lap bars are pulled back slightly (between the static neutral point and the point associated with zero speed) different amounts, a turn will result. Because the vehicle is moving backward, pulling the right lap bar back less than the left one should cause a turn with the right side on the inside of the turn, but because the lap bars are still in front of the static neutral position, the steering system will turn steerable wheels as if it was a turn while moving forward, thus the turn will be in the opposite direction.

The bottom row of FIG. 14 shows example inputs and steering response when operating a vehicle with a static neutral point facing downhill. Pushing the lap bars forward slightly from the point associated with zero speed (between the static neutral point and the point associated with zero speed) can result in forward vehicle movement even if the lap bars are still backward of neutral. With the static neutral point, however, turning when facing downhill can provide incorrect steering angles. If the lap bars are pushed forward slightly (between the static neutral point and the point associated with zero speed) different amounts, a turn will result. Because the vehicle is moving forward, pushing the right lap bar forward more than the left one should cause a turn with the left side on the inside of the turn, but because the lap bars are still behind the static neutral position, the steering system will turn steerable wheels as if it was a turn while moving backward, thus the turn will be in the opposite direction.

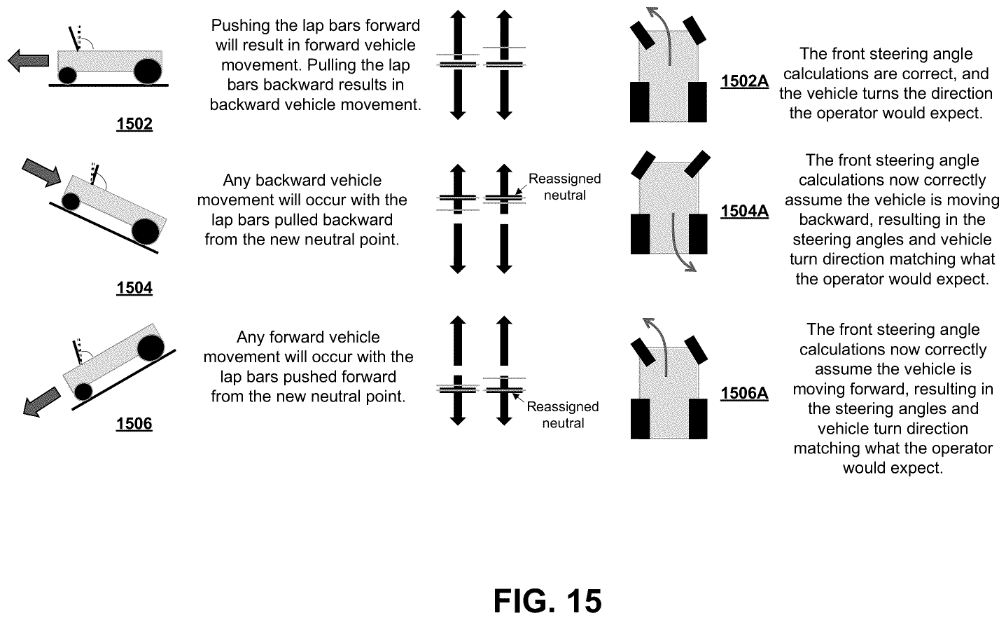

Referring to FIG. 15, illustrated is a diagram showing operation of a steering system with a floating neutral point on level ground, facing uphill, and facing downhill, in accordance with various aspects discussed herein.

The top row of FIG. 15 shows example inputs and steering response when operating a vehicle with a floating neutral point on level ground, where the floating neutral point is the same as a static neutral point, and similar behavior results. Pushing both lap bars forward results in forward movement, pulling both back results in backward movement, and pushing them both forward by different amounts results in a correct steering response, where the vehicle turns in an expected direction, turning in an arc toward the side with the lesser input.

The middle row of FIG. 15 shows example inputs and steering response when operating a vehicle with a floating neutral point facing uphill. The floating neutral point will be redefined based on the control input position(s) associated with zero speed (e.g., based on pitch angle or total acceleration, and optionally on engine RPM). Pulling the lap bars backward slightly from the point associated with zero speed (which is now also the redefined floating neutral point) can result in backward vehicle movement even if the lap bars are still forward of the mechanical neutral position. With the floating neutral point, turning when facing uphill provides correct steering angles. If the lap bars are pulled back slightly (between the mechanical neutral point and the point associated with zero speed, which is the floating neutral point) different amounts, a turn will result. Because the vehicle is moving backward, pulling the right lap bar back less than the left one should cause a turn with the right side on the inside of the turn, and because the lap bars are now behind the floating neutral position, the steering system will turn steerable wheels as if it was a turn while moving backward, thus the turn will be in the correct direction.

The bottom row of FIG. 15 shows example inputs and steering response when operating a vehicle with a floating neutral point facing downhill. Again, the floating neutral point will be redefined based on the control input position(s) associated with zero speed. Pushing the lap bars forward slightly from the point associated with zero speed (between the mechanical neutral point and the point associated with zero speed, which is the floating neutral point) can result in forward vehicle movement even if the lap bars are still backward of the mechanical neutral position. With the floating neutral point, turning when facing downhill provides correct steering angles. If the lap bars are pushed forward slightly (between the mechanical neutral point and the point associated with zero speed, which is the floating neutral point) different amounts, a turn will result. Because the vehicle is moving forward, pushing the right lap bar forward more than the left one should cause a turn with the left side on the inside of the turn, and because the lap bars are in front of the floating neutral position, the steering system will turn steerable wheels as if it was a turn while moving forward, thus the turn will be in the correct direction.

Although specifically discussed in connection with slopes, a floating neutral point can be employed in connection with all types of acceleration (e.g., as measured via an IMU (inertial measurement unit), etc.). Because a similar issue can result from rapid acceleration or deceleration, not just acceleration resulting from gravity, floating neutral point techniques can be used in connection with all acceleration experienced by a vehicle by determining the floating neutral point based on the total acceleration of the vehicle (e.g., as determined via IMU, etc.) instead of solely based on vehicle pitch angle.

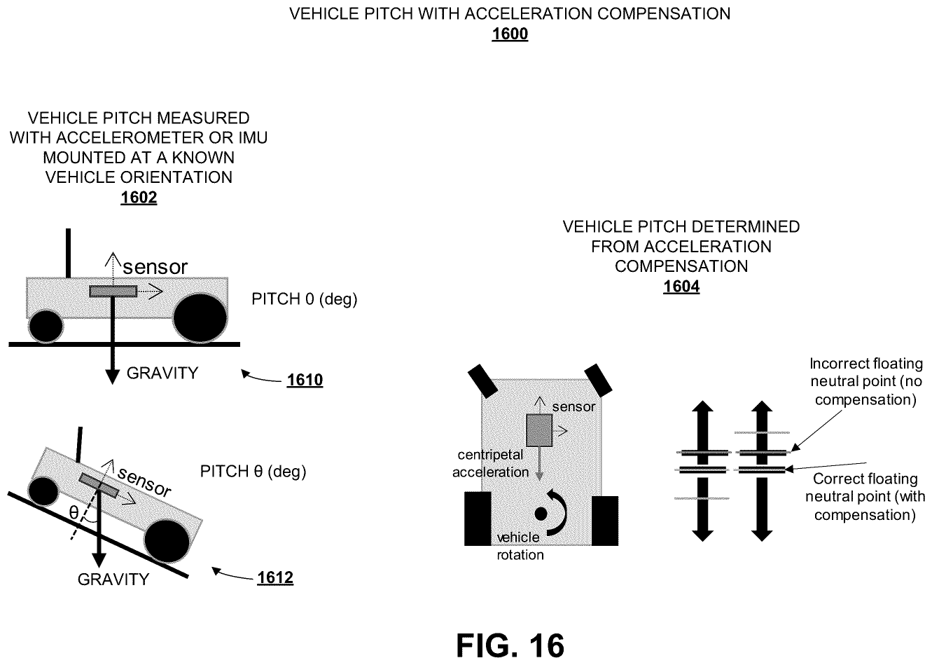

FIG. 16 depicts a diagram of vehicle pitch calculation that includes compensation for vehicle acceleration, in another aspect of the disclosed embodiments. In the aspect illustrated by FIG. 16, the acceleration sensor compensation subtracts non-gravitational accelerations, such as centripetal acceleration 1604, to isolate the gravitational vector in calculating vehicle pitch. Vehicle pitch measurement can be measured with an inertial measurement unit (IMU) and/or accelerometer device measuring pitch angle with respect to a direction of a gravitational vector 1602. Non-gravitational accelerations can be estimated from sensors such as a vehicle gyroscope, or calculated from control inputs, or the like, or suitable combinations of the foregoing. A vehicle with orthogonal orientation with respect to the gravitational vector direction has zero pitch 1610 whereas a non-orthogonal angle to the direction of the gravitational vector has non-zero pitch 1612 as shown. The pitch can be utilized for steering mechanism adjustments, such as a neutral point of a lapbar steering mechanism, or other independent left and right wheel drive and steering mechanism. The compensated versus non-compensated neutral point positions of the left drive mechanism and the right drive mechanism are shown.

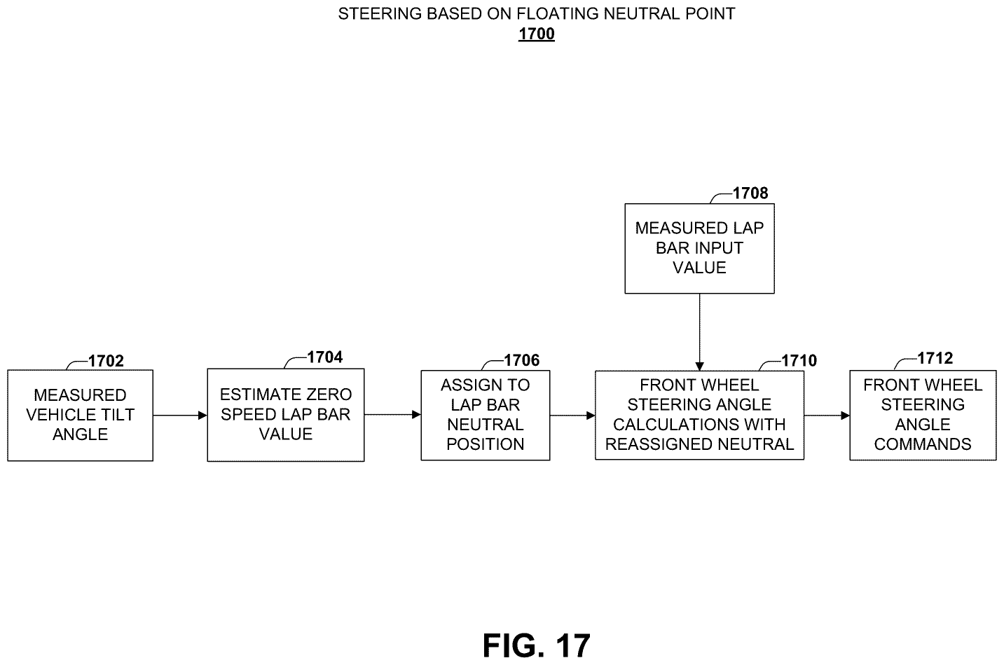

Referring to FIG. 17, illustrated is a flow diagram 1700 showing calculation of steering angle commands based on a floating neutral point, according to various aspects discussed herein.

At 1702, a vehicle tilt angle can be measured. Alternatively, as discussed above, a vehicle acceleration (e.g., including gravitational acceleration) can be measured, from which an effective tilt angle can be determined (e.g., by using the direction of total acceleration in place of the direction of gravity for determining the effective tilt angle, etc.).

At 1704, control input position(s) associated with zero speed can be estimated based on the tilt angle (or effective tilt angle). In some embodiments, determination of the control input position(s) associated with zero speed can also be based on engine revolutions per minute (RPM). Alternatively, drive wheel speed can be measured to determine the control output positions associated with zero speed.

At 1706, a floating neutral position for the control input(s) can be assigned to the position(s) associated with zero speed.

Separately, at 1708, actual control input position(s) can be measured or otherwise received.

At 1710, angles for steerable wheels (e.g., front wheels, etc.) can be calculated based on the floating neutral position(s) and actual control input position(s). This can involve determining whether the input(s) will result in steering while moving forward or backward, and what angles to turn steerable wheels to in order to achieve the commanded turn.

At 1712, steerable wheel steering angle commands can be output (e.g., to motor controller(s) for motor(s) configured to turn the steerable wheels to the commanded angles).

Open Loop Hill Holding and/or Hill Speed Compensation

Various embodiments can employ techniques to adjust commands to drive elements (e.g., wheels, etc.) to compensate for operating on a slope and/or based on total acceleration (e.g., including gravity). Embodiments employing these techniques can facilitate keeping a vehicle stationary on a hill while receiving no operator inputs and/or adjusting drive system commands based on slopes and/or acceleration. In various such embodiments, control inputs can be redefined to compensate based on a displacement in control inputs between mechanical neutral position(s) of the control input(s) and input position(s) associated with zero speed.

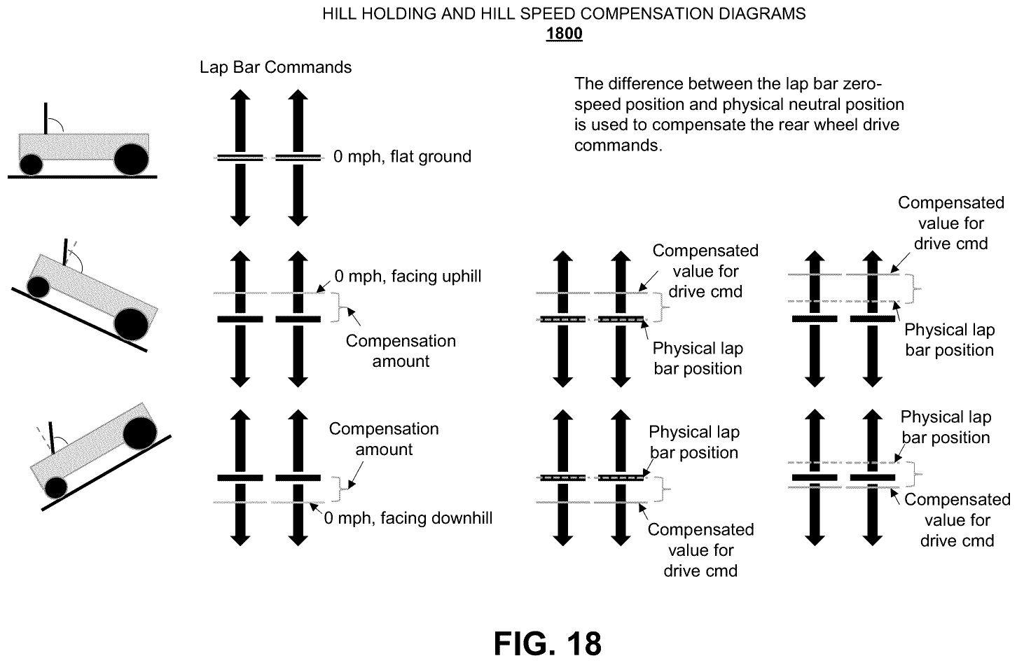

Referring to FIG. 18, illustrated is a diagram showing operation of a vehicle employing techniques discussed herein for hill holding and hill speed compensation on level ground (top row), facing uphill (middle row), and facing downhill (bottom row).

When the vehicle is on a hill, the user input position(s) corresponding to zero speed will vary based on the vehicle pitch angle and the direction the vehicle is facing. Hill holding and hill speed compensation techniques can adjust the drive wheel commands to compensate for the vehicle pitch angle, such that: (a) The vehicle maintains its speed on hilly terrain without adjustments from the operator; and/or (b) The operator can allow the user input control(s) to return to mechanical neutral on a hill without the vehicle rolling down the hill.

The user input position which corresponds to zero speed can be estimated based on the vehicle pitch angle (and optionally engine RPM, for gas-powered vehicles, etc.) without using feedback from the rear wheels, similarly to the floating neutral point techniques discussed above.

In the top row of FIG. 18, the vehicle is on level ground, so the input position(s) corresponding to zero speed is the mechanical neutral position(s), and no compensation is employed.

In the middle row of FIG. 18, the vehicle is facing uphill, such that the position associated with zero speed is forward of the mechanical neutral position. In the bottom row, the vehicle is facing downhill, such that the position associated with zero speed is behind the mechanical neutral position. In various embodiments, the actual input position of the control(s) can be compensated by the difference between the mechanical neutral position(s) and the position(s) associated with zero speed (first column showing control inputs). As a result, when the controls are in the mechanical neutral position (center column of control inputs), the output command is compensated based on the difference, and is commanded to the drive system as if the controls were at the position(s) associated with zero speed (in front of its actual position when facing uphill, and behind its actual position when facing downhill), so it will hold its position on the hill while the controls are at the mechanical neutral position. If the controls are displaced forward (or alternately, rearward) of the mechanical neutral position, the vehicle will move forward (or alternately, rearward) based on the amount of displacement from neutral, independently of whether the vehicle is facing uphill, downhill, or is on level ground (right column of control inputs).

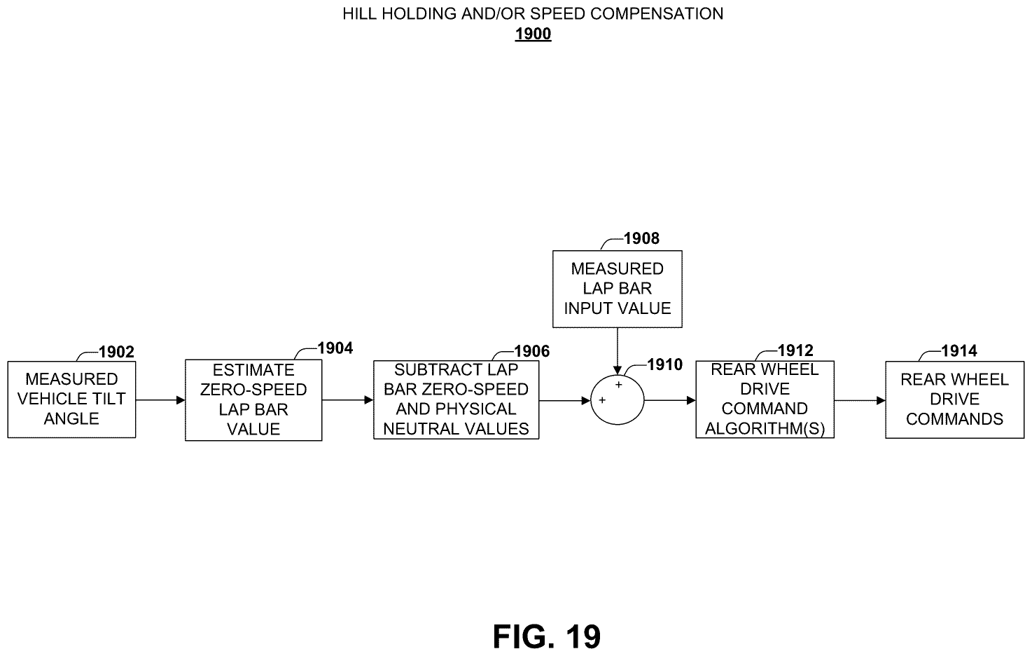

Referring to FIG. 19, illustrated is a flow diagram 1900 showing techniques for hill holding and/or hill speed compensation based on vehicle tilt angle, according to various aspects discussed herein.

At 1902, a vehicle tilt angle can be measured. Alternatively, as discussed above, a vehicle acceleration (e.g., including gravitational acceleration) can be measured, from which an effective tilt angle can be determined (e.g., by using the direction of total acceleration in place of the direction of gravity for determining the effective tilt angle, etc.).

At 1904, control input position(s) associated with zero speed can be estimated based on the tilt angle (or effective tilt angle) and optionally on engine RPM.

At 1906, a difference can be computed between mechanical or physical neutral position(s) of the control(s) and the estimated position(s) associated with zero speed.

Separately, at 1908, actual control input position(s) can be measured or otherwise received.

At 1910, the actual control input position(s) can be added (considering positions such that forward is positive and rearward is negative, with amounts varying based on the amount of displacement) to the computed difference to generate compensated input position(s). For example, with no tilt, the difference is zero and the compensated input position(s) are the actual input position(s). As another example, when facing uphill, the difference is positive/forward (with an amount varying based on amount of tilt) and will increase or move forward the actual input position(s) by an amount depending on the magnitude of the difference. As a third example, when facing downhill, the difference is negative/rearward (with an amount varying based on amount of tilt) and will decrease or move backward the actual input position(s) by an amount depending on the magnitude of the difference.

At 1912, the compensated input position(s) can be provided to one or more drive command algorithms, which can compute output command(s) based on the compensated input position(s). In one example, the algorithm can compute output command(s) from the compensated input position(s) in the same way as it would from actual input position(s) on flat ground. As another example, in an embodiment employing both these techniques for hill holding and/or hill speed compensation and hydrostatic loss emulation, the compensated input position(s) can be employed as control input(s) for the determination of hydrostatic loss emulation. Other examples and combinations can be employed in various embodiments.

At 1914, the output command(s) can be provided (e.g., to motor controller(s)) as drive command(s) for the drive element(s).

### Zero Turn Point Filtering

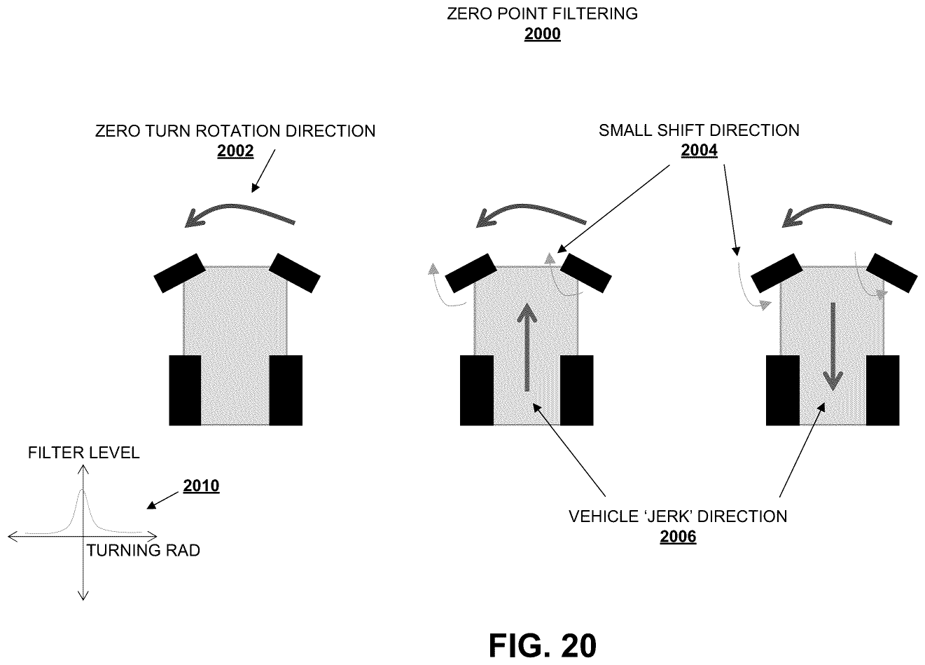

FIG. 20 depicts a diagram of zero point filtering 2000 to mitigate vehicle jerk during a zero or low radius turn in other aspects of the disclosed embodiments. FIG. 20 depicts a vehicle having a low radius or zero radius turn 2002. Rotational velocity can be relatively high for low radius turns, and as a result small deviations in steered wheel direction 2004 from the low radius turn can cause significant changes in acceleration, or jerking motion of the vehicle. The jerk direction 2005 depends on the deviation from the low radius turn path. A clockwise deviation (middle vehicle figure) looking downward upon the vehicle results in a forward vehicle jerk whereas counterclockwise deviation results in a reverse vehicle jerk, as shown in FIG. 20. The filter level 2010 can dampen control signal deviations that are small in magnitude to prevent unintended vehicle jerk. In various aspects, filtering depicted by filter level 2010 can be activated only in response to a steering control signal that creates a low radius turn, as shown in FIG. 20. Thus, filtering level 2010 can be activated only for low radius turns, in such aspects of the disclosed embodiments.

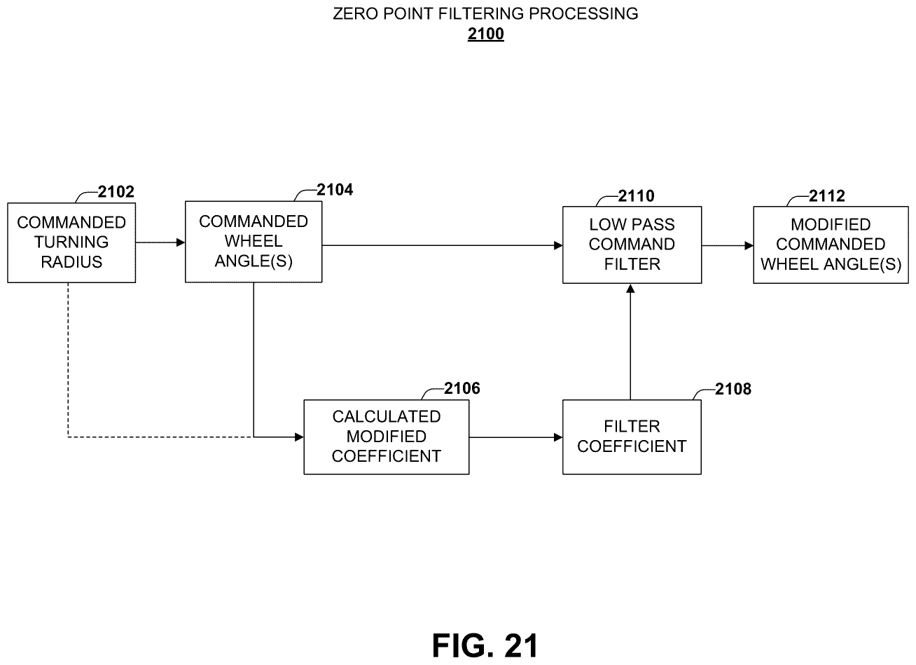

FIG. 21 depicts a flow chart of an example method 2100 for zero point filtering adjustment in wheel angle commands for a driven vehicle, in still other aspects of the disclosure. At 2102, method 2100 can comprise commanding a turning radius for a vehicle, and at 2104 method 2100 can comprise commanding a wheel angle(s) matching the turning radius. At 2106, method 2100 can comprise calculating a modified coefficient, and at 2108 method 2100 can comprise determining a filter coefficient. At 2110, method 2100 can comprise combining a commanded wheel angle and filter coefficient to generate a low pass command filter. At 2112, method 2100 can comprise generating and outputting a modified commanded wheel angle(s) for the vehicle.

### Rapidly Adjustable Top Speed

Various embodiments can provide for a scalable and/or selectable top speed that can be based in part on inputs from one or more of a user, a remote administrator, and/or automated inputs (e.g., based on time, location data such as presence in or proximity to locations and/or regions defined by a user or otherwise, such as locations defined by a user where the vehicle will move more slowly, for example to provide for greater precision in maneuvering a lawn maintenance apparatus around certain obstacles, etc.). These techniques can allow for scaling of the speed command range from control input(s) such as via the vehicle user input control(s) (e.g., joystick(s), lap bar(s), pedal(s), etc.), allowing for scaling of the speed command range at any suitable time, including during operation.

In embodiments employing adjustable top speed techniques, the system (e.g., via software, etc.) can remap a selected speed range to the full mechanical control input range (e.g., the forward range and the reverse range).

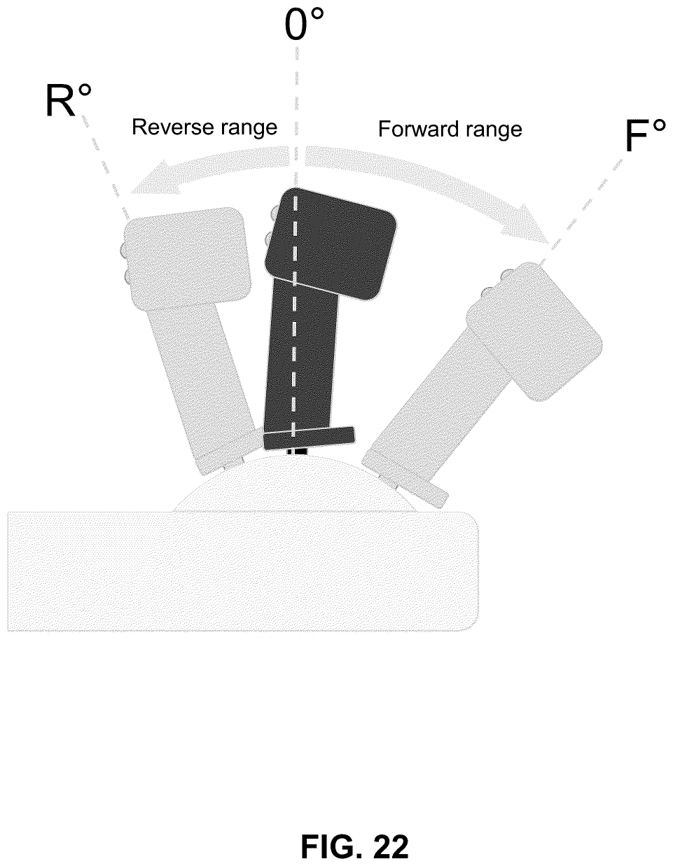

Referring to FIG. 22, illustrated is a diagram showing a joystick as an example user input with a mechanical range varying from a neutral position) (0° through a forward range (from 0° forward to F°) and reverse range (from 0° back to) R° that can be employed in connection with adjustable top speed techniques discussed herein. As one example, the top forward speed can be set to 12 MPH, such that a joystick (or other control input(s)) angle of F° will move the vehicle at 12 MPH, a joystick (or other control input(s)) angle of 0° will move the vehicle at 0 MPH, and angles in between the two will provide speeds between 0 MPH and 12 MPH (e.g., scaled linearly, scaled non-linearly, scaled linearly/non-linearly with damping of very low inputs, etc.). As another example, the top forward speed can be set to 6 MPH, such that a joystick (or other control input(s)) angle of F° will move the vehicle at 6 MPH, a joystick (or other control input(s)) angle of 0° will move the vehicle at 0 MPH, and angles in between the two will provide speeds between 0 MPH and 6 MPH (e.g., scaled linearly, scaled non-linearly, scaled linearly/non-linearly with damping of very low inputs, etc.).

The top speed or speeds (e.g., forward and reverse) can be selected by various means, such as via any of a variety of suitable user inputs (e.g., slider, dial, display screen input, buttons, current control input position(s) combined with one or more other inputs, etc.), via an algorithm (e.g., for autonomous or semi-autonomous driving, etc.), etc. Additionally, the selected top speed can be indicated via any of a variety of suitable means (e.g., symbolically such as via one of a plurality of icons (e.g., a rabbit and a turtle, etc.), numerically, via a ramp indicator, via hash marks, etc.). In various embodiments the forward and reverse speed ranges can be equal or unequal, can depend on one another or be independent, etc.

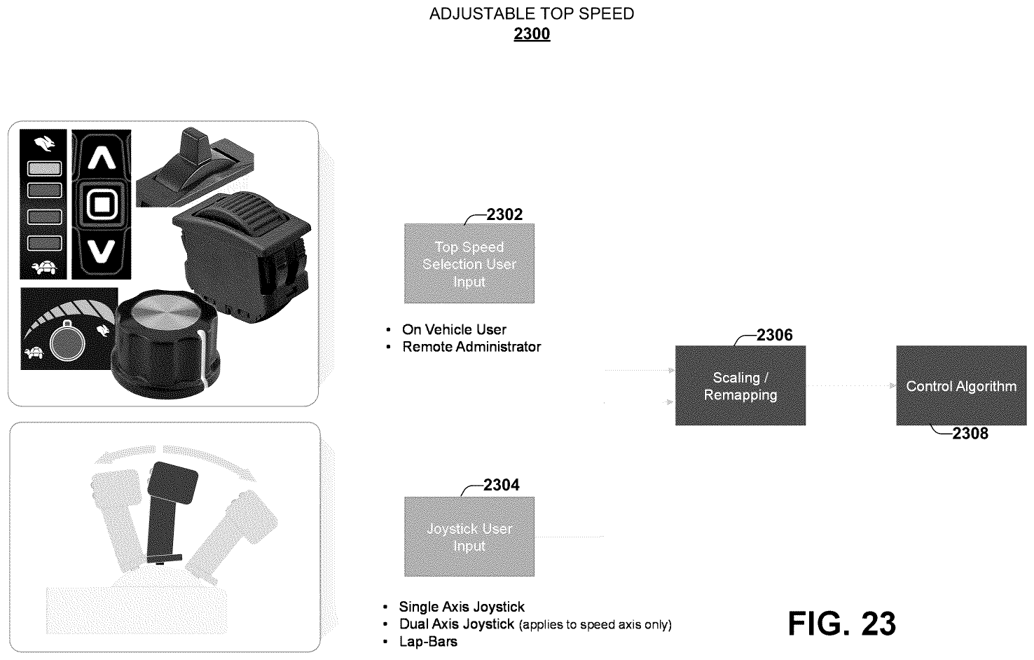

Referring to FIG. 23, illustrated are images showing example inputs for speed range selection (top left) and control input(s) within a selected speed range (bottom left) and a flow diagram 2300 showing control of vehicle speed based on those inputs, according to various aspects discussed herein.

At 2302, a top speed range selection(s) can be received (e.g., from user input, from a remote administrator, automatically triggered such as based on location/proximity/timing/etc.).

At 2304, control input(s) can be received (e.g., via any of a variety of suitable control input(s), such as via algorithm, via operator controls such as single axis joystick(s), dual axis joystick(s), lap bars, etc.).

At 2306, the control input(s) from 2304 can be scaled or remapped to speeds within the top speed range (or relevant top speed range if separate forward and reverse ranges exist) from 2302.

At 2308, the remapped control input(s) can be provided to a control algorithm to generate drive system output(s) based on the remapped control input(s). In various embodiments, the drive system output(s) can also depend on one or more aspects discussed herein (e.g., variable output damping, hydro loss emulation, etc.).

### Embodiments Employing Multiple Techniques

As discussed above, the systems, methods, and techniques discussed herein can be employed separately or in substantially any suitable combination in various embodiments. In embodiments combining either floating neutral point or hill holding/hill speed compensation with other techniques (e.g., variable output damping, drive system loss compensation steering, hydro loss emulation, speed range adjustment, etc.), the floating neutral point and/or hill holding/hill speed compensation can be applied first to operator input(s), and the input(s) thereby modified can be employed as input(s) for other techniques. In embodiments combining casterless steerable wheels with other techniques, the angle(s) selected for the casterless steerable wheel(s) can be determined based on input(s) as modified by other techniques. In embodiments combining variable output damping with speed range adjustment, damping can be applied based on the range of potential mechanical input(s) or potentially scaled based on the adjusted speed range(s).

### Additional Embodiments

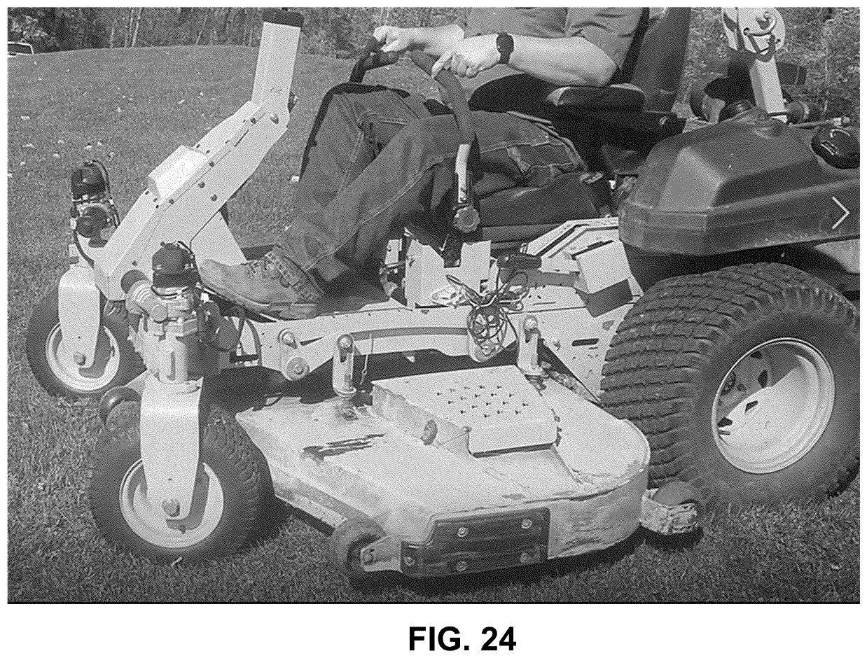

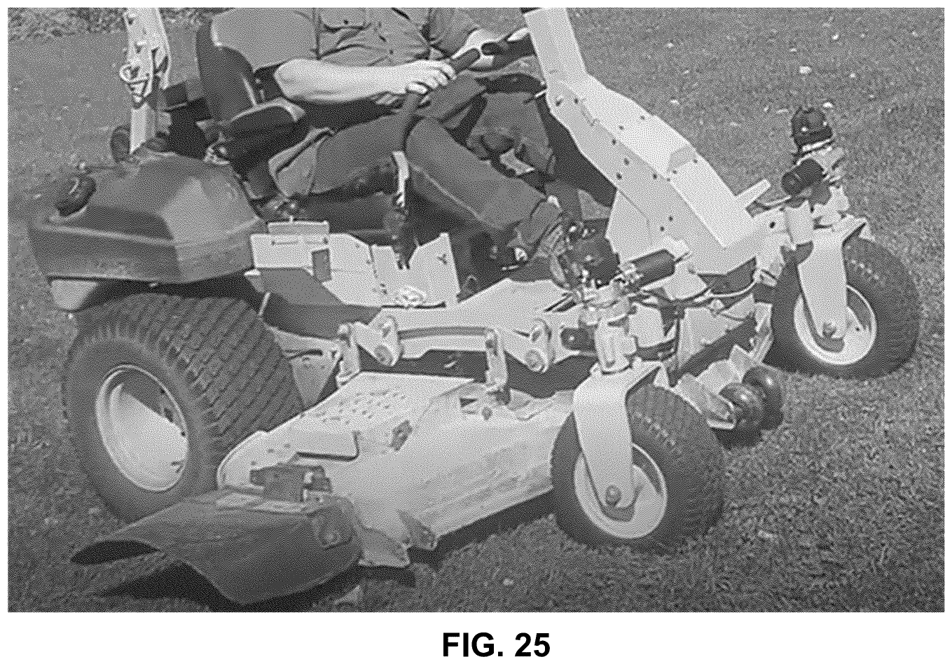

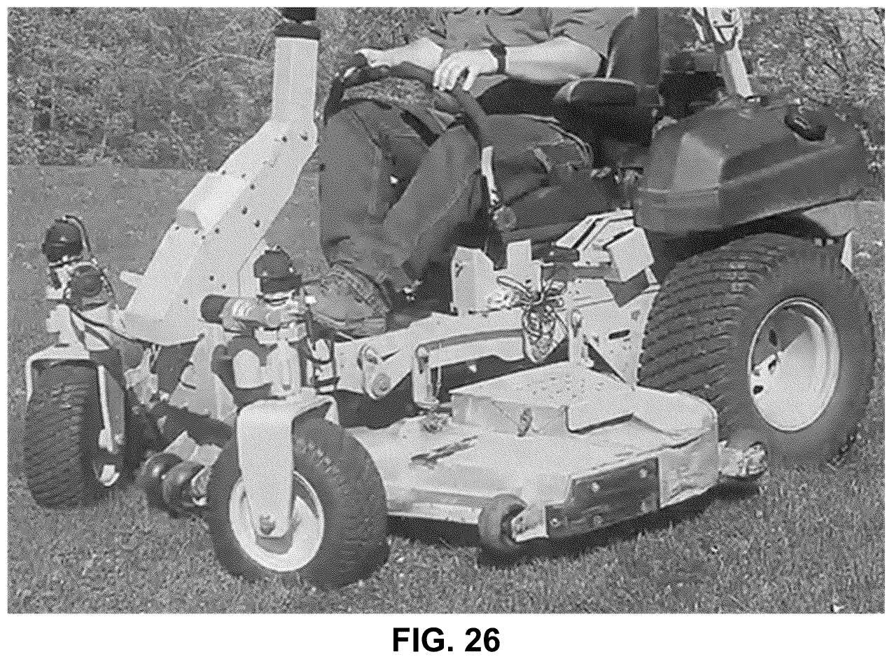

FIGS. 24-26 present various views of a prototype employing casterless steerable front wheels and other techniques discussed herein.

Referring to FIG. 27, illustrated is an example drive-by-wire control system 2700 capable of implementing one or more of the methods or techniques discussed herein. In various embodiments, some components of system 2700 can be optional. For example, for systems only controlling or adjusting speed, steering control system 2740 can be optional. As another example, for systems only controlling steerable non-drive wheels, drive control system 2730 can be omitted.

System 2700 can comprise operator control(s) 2710 (e.g., local and/or remote controls, although in some embodiments configured for autonomous driving operator control(s) 2710 can be omitted), control unit 2720, drive control system 2730, steering control system 2740, and sensor(s) and/or other data sources 2750. Drive control system 2730 can comprise one or more drive motor controllers 2732, one or more drive motors 2734, and one or more drive elements 2736. Steering control system 2740 can comprise one or more steering motor controllers 2742, one or more steering motors 2744, and one or more steerable wheels 2746. In various embodiments, operator control(s) 2710, control unit 2720, steering control system 2730, drive control system 2740, and/or sensor(s)/other data sources 2750 can communicate with one another over one or more wired and/or wireless communications links (not shown), such as a CAN (Controller Area Network) bus, etc.

An operator can provide input(s) via operator control(s) 2710, which can comprise speed and/or steering controls such as lap bars, joystick(s), etc., but can also comprise other inputs such as a display screen, buttons, knobs, etc., which can control various functions (e.g., selection of a speed range, etc.).

Control unit 2720 can receive operator input(s) and optionally other data from sensor(s) and/or other data sources 2750, which can include pitch data, acceleration data, location data (e.g., via GPS and/or GPS-RTK, etc.), remote commands (e.g., from a remote operator/administrator, etc.), etc. Based on the operator input(s) and/or data from sensor(s) and/or other data sources 2750, control unit 2720 can apply one or more of the methods or techniques discussed herein to generate control output(s) to control one or more of drive control system 2730 or steering control system 2740.

Drive control output(s) from control unit 2720 can be received by one or more drive motor controllers 2732, which can operate one or more drive motors 2734 based on the received drive control outputs. Drive motor(s) 2734 can rotate (e.g., at a commanded speed/direction) drive element(s) 2736 (e.g., drive wheels, tracks, etc.) based on received signaling from drive motor controller(s) 2736.

Similarly, steering control output(s) from control unit 2720 can be received by one or more steering motor controllers 2742, which can operate one or more steering motors 2744 based on the received steering control outputs. Steering motor(s) 2744 can rotate (e.g., at a commanded speed/direction) steerable wheel(s) 2746 (e.g., drive wheels, tracks, etc.) based on received signaling from steering motor controller(s) 2746.

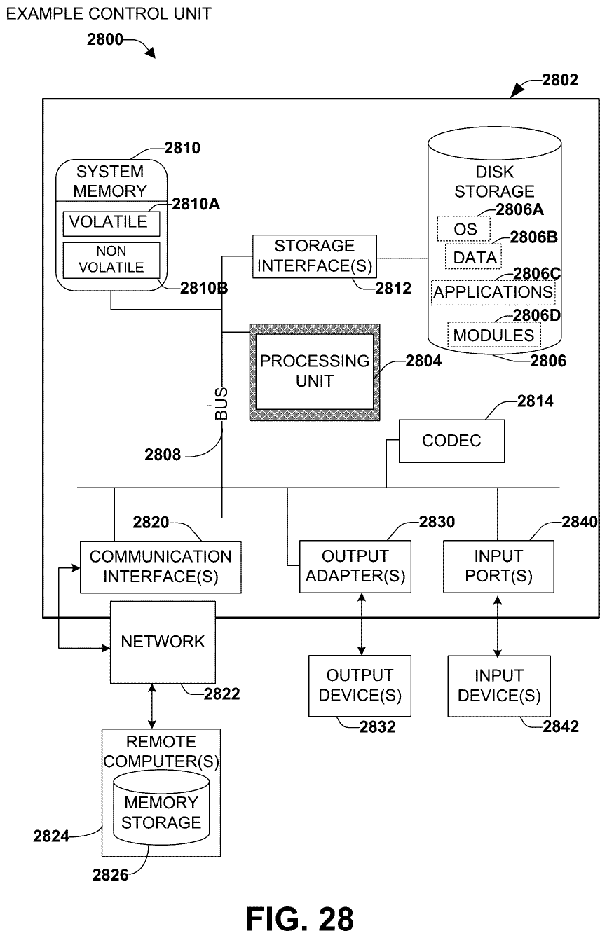

In connection with FIG. 28, the systems and processes described herein can be embodied within hardware, such as a single integrated circuit (IC) chip, multiple ICs, an application specific integrated circuit (ASIC), or the like. A suitable control unit 2800 for implementing various aspects of the claimed subject matter includes a computer 2802. In various embodiments, a control unit of a vehicle can be embodied in part by computer 2802, or an analogous computing device known in the art, subsequently developed, or made known to one of ordinary skill in the art by way of the context provided herein.

The computer 2802 can include a processing unit 2804, a system memory 2810, a codec 2814, and a system bus 2808. The system bus 2808 couples system components including, but not limited to, the system memory 2810 to the processing unit 2804. The processing unit 2804 can be any of various suitable processors. Dual microprocessors and other multiprocessor architectures also can be employed as the processing unit 2804.

The system bus 2808 can be any of several types of suitable bus structure(s) including the memory bus or memory controller, a peripheral bus or external bus, or a local bus using any variety of suitable bus architectures including, but not limited to, Controller Area Network (CAN), Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 2810 can include volatile memory 2810A, non-volatile memory 2810B, or both. Operating instructions of a control unit (among other control units: 2720, etc., depicted herein) described in the present specification can be loaded into system memory 2810, in various embodiments, upon startup of computer 2802. The basic input/output system (BIOS), containing the basic routines to transfer information between elements within the computer 2802, such as during start-up, is stored in non-volatile memory 2810B. In addition, according to present innovations, codec 2814 may include at least one of an encoder or decoder, wherein the at least one of the encoder or decoder may consist of hardware, software, or a combination of hardware and software. Although, codec 2814 is depicted as a separate component, codec 2814 may be contained within non-volatile memory 2810B. By way of illustration, and not limitation, non-volatile memory 2810B can include read only memory (ROM), programmable ROM (PROM), electrically programmable ROM (EPROM), electrically erasable programmable ROM (EEPROM), or Flash memory. Non-volatile memory 2810B can be embedded memory (e.g., physically integrated with computer 2802 or a mainboard thereof), or removable memory. Examples of suitable removable memory can include a secure digital (SD) card, a compact Flash (CF) card, a universal serial bus (USB) memory stick, or the like. Volatile memory 2810A includes random access memory (RAM), which can serve as operational system memory for applications executed by processing unit 2804. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM), and so forth.

Computer 2802 may also include removable/non-removable, volatile/non-volatile computer storage medium. FIG. 28 illustrates, for example, disk storage 2806. Disk storage 2806 includes, but is not limited to, devices such as a magnetic disk drive, solid state disk (SSD) floppy disk drive, tape drive, Flash memory card, memory stick, or the like. In addition, disk storage 2806 can include storage medium separately or in combination with other storage medium including, but not limited to, an optical disk drive such as a compact disk ROM device (CD-ROM) or derivative technology (e.g., CD-R Drive, CD-RW Drive, DVD-ROM, and so forth). To facilitate connection of the disk storage 2806 to the system bus 2808, a removable or non-removable interface is typically used, such as interface 2812. In one or more embodiments, disk storage 2806 can be limited to solid state non-volatile storage memory, providing motion and vibration resistance for a control unit (e.g., control unit 2720, among others) operable in conjunction with a vehicle (e.g., lawn maintenance apparatus 100, etc.).

It is to be appreciated that FIG. 28 describes software stored at non-volatile computer storage media (e.g., disk storage 2806) utilized to operate a disclosed control unit 2800 to provide drive-by-wire steering to a vehicle (e.g., lawn maintenance apparatus 100 disclosed hereinabove). Such software includes an operating system 2806A. Operating system 2806A, which can be stored on disk storage 2806, acts to control and allocate resources of the computer 2802. Applications 2806C take advantage of the management of resources by operating system 2806A through program modules 2806D, and program data 2806B, such as the boot/shutdown transaction table and the like, stored either in system memory 2810 or on disk storage 2806. It is to be appreciated that the claimed subject matter can be implemented with various operating systems or combinations of operating systems.

Input device(s) 2842 connects to the processing unit 2804 and facilitates user interaction with control unit 2800 through the system bus 2808 via interface port(s) 2830. Input port(s) 2840 can include, for example, a serial port, a parallel port, a game port, a universal serial bus (USB), among others. Output device(s) 2832 use some of the same type of ports as input device(s) 2842. Thus, for example, a USB port may be used to provide input to computer 2802 and to output information from computer 2802 to an output device 2832. Output adapter 2830 is provided to illustrate that there are some output devices, such as graphic display, speakers, and printers, among other output devices, which require special adapters. The output adapter 2830 can include, by way of illustration and not limitation, video and sound cards that provide a means of connection between the output device 2832 and the system bus 2808. It should be noted that other devices or systems of devices provide both input and output capabilities such as remote computer(s) 2824 and memory storage 2826.

Computer 2802 can operate in conjunction with one or more electronic devices described herein. For instance, computer 2802 can facilitate steering of non-driven wheels and/or driving of driven wheels, as described herein. Additionally, computer 2802 can communicatively couple with motors controlling steering angles and/or rotational speed of various non-driven wheels and/or drive elements, respectively, according to one or more aspects discussed herein.

Communication connection(s) 2820 refers to the hardware/software employed to connect the network interface 2822 to the system bus 2808. While communication connection 2820 is shown for illustrative clarity inside computer 2802, it can also be external to computer 2802. The hardware/software necessary for connection to the network interface 2822 includes, for exemplary purposes only, internal and external technologies such as, modems including regular telephone grade modems, cable modems and DSL modems, ISDN adapters, and wired and wireless Ethernet cards, hubs, and routers.

In regard to the various functions performed by the above described components, machines, devices, processes and the like, the terms (including a reference to a “means”) used to describe such components are intended to correspond, unless otherwise indicated, to any suitable component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other suitable features of the other implementations as may be desired and advantageous for a given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An outdoor power equipment, comprising:
a frame;
one or more drive elements coupled to the frame;
a control unit configured to generate a first steering output based at least in part on one or more control inputs; and
a steering system, comprising:
a first steerable wheel coupled to the frame, wherein the first steerable wheel has zero caster trail;
one or more steering motor controllers configured to receive the first steering output and to generate a first motor control signal based on the first steering output; and
one or more steering motors configured to rotate the first steerable wheel to a first angle based on the first motor control signal.

2. The outdoor power equipment of claim 1,
wherein the control unit is further configured to generate a second steering output based at least in part on the one or more control inputs,
wherein the steering system further comprises a second steerable wheel coupled to the frame, wherein the second steerable wheel has zero caster trail,
wherein the one or more steering motor controllers are further configured to receive the second steering output and to generate a second motor control signal based on the second steering output, and
wherein the one or more steering motors are further configured to rotate the second steerable wheel to a second angle based on the second motor control signal.

3. The outdoor power equipment of claim 2, wherein the one or more steering motor controllers comprise a first steering motor controller configured to receive the first steering output and a second steering controller motor configured to receive the second steering output.

4. The outdoor power equipment of claim 3, wherein the one or more steering motors comprise a first steering motor configured to rotate the first steerable wheel and a second steering motor configured to rotate the second steerable wheel.

5. The outdoor power equipment of claim 1,
wherein the first steerable wheel is at a first current angle,
wherein the one or more control inputs are associated with a first commanded angle for the first steerable wheel, and
wherein the control unit is further configured to:
select the first commanded angle as the first angle when the first target angle is less than or equal to 90° away from the first current angle; and
select the first commanded angle plus 180° as the first angle when the first target angle is greater than 90° away from the first current angle.

6. The outdoor power equipment of claim 1, further comprising operator controls configured to receive the one or more control inputs.

7. The outdoor power equipment of claim 1, wherein the control unit is further configured to generate the one or more control inputs in connection with one of an autonomous driving algorithm or a semi-autonomous driving algorithm.

8. An outdoor power equipment, comprising:
a frame; and
a control unit configured to:
calculate at least one damping parameter based at least in part on one or more control inputs associated with at least one of driving the outdoor power equipment or steering the outdoor power equipment;
calculate at least one control output value based at least in part on the operator input;
generate a damped control output value by applying a damping function based on the at least one damping parameter to the at least one control output value; and
output a vehicle control output to at least one motor controller based on the damped control output value.

9. The outdoor power equipment of claim 8, wherein the control unit is configured to calculate the at least one damping parameter based on the one or more control inputs as filtered by a first filter and to calculate the at least one control output value based on the operator input as filtered by the first filter.

10. The outdoor power equipment of claim 8, wherein the damping function is a low-pass filter with a variable alpha value, and wherein the control unit is configured to calculate the variable alpha value based on the one or more control inputs and optionally a vehicle pitch value or a vehicle engine rotation per minute (rpm).

11. The outdoor power equipment of claim 8, wherein the damping function is a moving average filter with a variable number of data points, and wherein the control unit is configured to calculate the variable number of data points based on the one or more control inputs and optionally a vehicle pitch value or a vehicle engine rpm.

12. The outdoor power equipment of claim 8, wherein the damping function is a slew rate control with a variable slope and wherein the control unit is configured to calculate the variable slope based on the one or more control inputs and optionally a vehicle pitch value or a vehicle engine rpm.

13. The outdoor power equipment of claim 8, wherein the outdoor power equipment further comprises one or more drive elements coupled to the frame, wherein the operator input is associated with driving the outdoor power equipment, and wherein the one or more motor controllers are configured to control rotation of the one or more drive elements via one or more drive motors based on the vehicle control output.

14. The outdoor power equipment of claim 8, wherein the outdoor power equipment further comprises one or more steerable wheels coupled to the frame, wherein the operator input is associated with steering the outdoor power equipment, and wherein the one or more motor controllers are configured to control rotation of the one or more steerable wheels via one or more steering motors based on the vehicle control output.

15. The outdoor power equipment of claim 8, further comprising operator controls configured to receive the one or more control inputs.

16. The outdoor power equipment of claim 8, wherein the control unit is further configured to generate the one or more control inputs in connection with one of an autonomous driving algorithm or a semi-autonomous driving algorithm.

17. An outdoor power equipment, comprising:
a frame;
a left drive element coupled to the frame and a right drive element coupled to the frame, wherein the left and right drive elements are configured to be driven independently of each other;
a left steerable wheel coupled to the frame and a right steerable wheel coupled to the frame; and
a control unit configured to:
receive a left control input associated with the left drive element and a right control input associated with the right drive element;
generate a left drive element command and a right drive element command based at least in part on the left control input and the right control input;
determine an estimated left drive element response and an estimated right drive element response based at least in part on the left control input and the right control input;
generate a left steering command based at least in part on the estimated left drive element response and the estimated right drive element response; and
generate a right steering command based at least in part on the estimated left drive element response and the estimated right drive element response; and
a steering control system configured to receive the left steering command and the right steering command, to rotate the left steerable wheel to a left steering angle associated with the left steering command, and to rotate the right steerable wheel to a right steering angle associated with the right steering command.

18. The outdoor power equipment of claim 17, wherein the estimated left drive element response is based on an estimated response of a first transmission based on the left drive element command and on an estimated response of a second transmission based on the right drive element command, and wherein the estimated right drive element response is based on the estimated response of the first transmission based on the left drive element command and on the estimated response of the second transmission based on the right drive element command.

19. The outdoor power equipment of claim 18, wherein the outdoor power equipment comprises the first transmission and the second transmission, wherein the first transmission is configured to drive the left drive element based on the left drive element command, and wherein the second transmission is configured to drive the right drive element based on the right drive command.

20. The outdoor power equipment of claim 18, wherein the left drive element is driven at least one of mechanically or electrically, and wherein the right drive element is driven at least one of mechanically or electrically.

21. The outdoor power equipment of claim 20, wherein the left drive element command is generated at least in part on the estimated left drive element response, and wherein the right drive element command is generated at least in part on the estimated right drive element response.

22. The outdoor power equipment of claim 17, further comprising operator controls configured to receive the left and right control inputs.

23. The outdoor power equipment of claim 17, wherein the control unit is further configured to generate the left and right control inputs in connection with one of an autonomous driving algorithm or a semi-autonomous driving algorithm.

24. An outdoor power equipment, comprising:
a frame;
a left drive element coupled to the frame and a right drive element coupled to the frame, wherein the left and right drive elements are configured to be driven independently of each other, wherein the left drive element is driven at least one of mechanically or electrically, and wherein the right drive element is driven at least one of mechanically or electrically; and
a control unit configured to:
receive a left control input associated with the left drive element and a right control input associated with the right drive element;
generate a left drive element command based at least in part on the left control input and the right control input; and
generate a right drive element command based at least in part on the left control input and the right control input;
wherein the left drive element is configured to be driven based on the left drive element command, and wherein the right drive element is configured to be driven based on the right drive element command.

25. The outdoor power equipment of claim 24, wherein the left drive element command is generated based at least in part on estimated hydrostatic responses to the left control input and the right control input, and wherein the right drive element command is generated based at least in part on the estimated hydrostatic responses to the left control input and the right control input.

26. The outdoor power equipment of claim 24, further comprising operator controls configured to receive the left and right control inputs.

27. The outdoor power equipment of claim 24, wherein the control unit is further configured to generate the left and right control inputs in connection with one of an autonomous driving algorithm or a semi-autonomous driving algorithm.

28. An outdoor power equipment, comprising:
a frame;
one or more drive elements coupled to the frame;
one or more steerable elements coupled to the frame;
operator controls configured to receive one or more operator inputs; and
a control unit configured to:
receive at least one of vehicle pitch data or vehicle acceleration data;
determine an effective tilt angle based on the at least one of the vehicle pitch data or the vehicle acceleration data;
estimate a zero position for the operator controls that is associated with zero speed based on the effective tilt angle;
assign the zero position as a neutral position of the operator controls;
receive the one or more operator inputs via the operator controls;
calculate an associated steering angle for each steerable element of the one or more steerable elements based on the one or more operator inputs relative to the neutral position; and
output an associated steering angle command based on each of the associated steering angles;
wherein each of the one or more steerable elements is configured to be steered based on the associated steering angle command based on the associated steering angle for that steerable element.

29. The outdoor power equipment of claim 28, wherein the control unit is configured to calculate the left steering angle and the right steering angle based at least in part on a determination of whether the one or more operator inputs are associated with forward motion or rearward motion based on the neutral position.

30. The outdoor power equipment of claim 28, wherein the effective tilt angle is determined based on the vehicle pitch data.

31. The outdoor power equipment of claim 28, wherein the effective tilt angle is determined based on the vehicle acceleration data.

32. The outdoor power equipment of claim 28, wherein the zero position for the operator controls is also estimated based at least in part on a rotational speed of an engine of the outdoor power equipment.

33. An outdoor power equipment, comprising:
a frame;
one or more drive elements coupled to the frame;
operator controls configured to receive one or more operator inputs; and
a control unit configured to:
receive at least one of vehicle pitch data or vehicle acceleration data;
determine an effective tilt angle based on the at least one of the vehicle pitch data or the vehicle acceleration data;
estimate a zero position for the operator controls that is associated with zero speed based on the effective tilt angle;
compute a difference between the estimated zero position and a mechanical neutral position for the operator controls;
determine one or more compensated operator inputs based on the one or more operator inputs and the difference between the estimated zero position and the mechanical neutral position;
generate one or more drive element commands for the two drive elements based on the one or more compensated operator inputs; and
output the one or more drive element commands;
wherein the one or more drive elements are configured to be driven based on the one or more drive element commands.

34. The outdoor power equipment of claim 33, wherein, when the operator controls are at the mechanical neutral position, the one or more compensated operator inputs correspond to the estimated zero position.

35. The outdoor power equipment of claim 33, wherein the effective tilt angle is determined based on the vehicle pitch data.

36. The outdoor power equipment of claim 33, wherein the effective tilt angle is determined based on the vehicle acceleration data.

37. The outdoor power equipment of claim 33, wherein the zero position for the operator controls is also estimated based at least in part on a rotational speed of an engine of the outdoor power equipment.

38. An outdoor power equipment, comprising:
a frame;
one or more drive elements coupled to the frame; and
a control unit configured to:
receive a selected top speed input, wherein the selected top speed is associated with a maximum forward speed and a maximum rearward speed;
receive one or more control inputs;
generate one or more scaled control inputs based on the selected top speed input and the one or more control inputs, wherein a maximum forward control input corresponds to the maximum forward speed and a maximum rearward control input corresponds to the maximum rearward speed;
generate one or more drive element commands based on the one or more scaled control inputs; and
output the one or more drive element commands;
wherein the one or more drive elements are configured to be driven based on the one or more drive element commands.

39. The outdoor power equipment of claim 38, further comprising operator controls configured to receive the one or more control inputs.

40. The outdoor power equipment of claim 39, wherein the operator controls are further configured to generate an output indicating the selected top speed input.

41. The outdoor power equipment of claim 39, wherein the selected top speed input is based on operator input.

42. The outdoor power equipment of claim 38, wherein the control unit is further configured to generate the one or more control inputs in connection with one of an autonomous driving algorithm or a semi-autonomous driving algorithm.

43. The outdoor power equipment of claim 38, wherein the selected top speed input is based on a remote command.

44. The outdoor power equipment of claim 38, wherein the selected top speed input is based on an automatic trigger.

45. An outdoor power equipment, comprising:
a frame;
one or more drive elements coupled to the frame;
a control unit configured to generate a first steering output based at least in part on one or more control inputs; and
a steering system, comprising:
a first steerable element coupled to the frame, wherein the first steerable element is symmetric;
one or more steering motor controllers configured to receive the first steering output and to generate a first motor control signal based on the first steering output; and
one or more steering motors configured to rotate the first steerable element to a first angle based on the first motor control signal.

46. The outdoor power equipment of claim 45,
wherein the control unit is further configured to generate a second steering output based at least in part on the one or more control inputs,
wherein the steering system further comprises a second steerable element coupled to the frame, wherein the second steerable element is symmetric,
wherein the one or more steering motor controllers are further configured to receive the second steering output and to generate a second motor control signal based on the second steering output, and
wherein the one or more steering motors are further configured to rotate the second steerable element to a second angle based on the second motor control signal.

47. The outdoor power equipment of claim 46, wherein the one or more steering motor controllers comprise a first steering motor controller configured to receive the first steering output and a second steering controller motor configured to receive the second steering output.

48. The outdoor power equipment of claim 47, wherein the one or more steering motors comprise a first steering motor configured to rotate the first steerable element and a second steering motor configured to rotate the second steerable element.

49. The outdoor power equipment of claim 45,
wherein the first steerable element is at a first current angle,
wherein the one or more control inputs are associated with a first commanded angle for the first steerable element, and
wherein the control unit is further configured to:
select the first commanded angle as the first angle when the first target angle is less than or equal to 90° away from the first current angle; and
select the first commanded angle plus 180° as the first angle when the first target angle is greater than 90° away from the first current angle.

50. The outdoor power equipment of claim 45, further comprising operator controls configured to receive the one or more control inputs.

51. The outdoor power equipment of claim 45, wherein the control unit is further configured to generate the one or more control inputs in connection with one of an autonomous driving algorithm or a semi-autonomous driving algorithm.

52. A control unit for an outdoor power equipment, comprising:
a control unit signal input that receives a steering control signal for a steered wheel of the outdoor power equipment;
a control unit signal output that generates a modified steering control signal to a steering motor controller to drive the steered wheel according to the modified steering control signal;
a memory module that stores a steering control signal value or range of steering control signal values associated with a zero radius turn for the steered wheel of the outdoor power equipment;
a comparator module that determines whether a value of the steering control signal matches the steering control signal value or the range of steering control signal values associated with the zero radius turn for the steered wheel;
and a filter module that suppresses low magnitude steering control signal value changes received at the control unit signal input from affecting the modified steering control signal output by the control unit signal output in response to the comparator determining the value of the steering control signal matches the steering control signal value or the range of the steering control signal values associated with the zero turn, wherein the low magnitude steering control signal value changes correspond to a rotation in the steered wheel between about zero degrees and about seven degrees from an angle associated with the zero radius turn for the steered wheel.

53. The control unit of claim 52, wherein the filter module does not suppress steering control signal value changes received at the control unit signal input from affecting the modified steering control signal output in response to the comparator determining the value of the steering control signal does not match the steering control signal value or range of steering control signal values associated with the zero radius turn.

54. The control unit of claim 52, wherein the filter module utilizes a low pass filter that applies high suppression to small changes in the steering control signal from the steering control signal value or range of steering control signal values associated with the zero radius turn and applies low to zero suppression to changes in the steering control signal that exceed the range of steering control signal values.
